(19) United States
(12) Patent Application Publication
(10) Pub. No.: US 2019/0386551 A1
(43) Pub. Date: Dec. 19, 2019

(54) COIL, ROTATING ELECTRICAL MACHINE, ROTATING ELECTRICAL MACHINE SYSTEM, AND METHOD OF MANUFACTURING PERMANENT MAGNET

(71) Applicant: MITSUBISHI HEAVY INDUSTRIES, LTD., Tokyo (JP)

(72) Inventors: Mikito SASAKI, Tokyo (JP); Shinichi ISOBE, Tokyo (JP); Masayuki SAKAI, Tokyo (JP); Hisanobu SHINODA, Tokyo (JP); Keisuke Ota, Tokyo (JP); Ryoji OKABE, Tokyo (JP)

(21) Appl. No.: 16/424,956

(22) Filed: May 29, 2019

(30) Foreign Application Priority Data
Jun. 13, 2018 (JP) 2018-112849
Feb. 8, 2019 (JP) 2019-021693

(51) Int. Cl. H02K 21/24; H02K 1/02; H02K 1/12; H02K 1/22; H02K 3/47

(52) U.S. Cl. CPC H02K 21/24; H02K 1/02; H02K 3/47; H02K 1/22; H02K 1/12

(57) ABSTRACT

An inner coil end portion of a coil includes inner notch portions and that are positioned to respectively overlap inner coil end portions of other coils which are adjacent to the coil in an axial direction as seen in the axial direction, and that are capable of accommodating the inner coil end portions of the other coils in the axial direction. An outer coil end portion of the coil includes outer notch portions and that are positioned to respectively overlap outer coil end portions of the other coils which are adjacent to the coil in the axial direction as seen in the axial direction, and that are capable of accommodating the outer coil end portions of the other coils in the axial direction.

### BACKGROUND OF THE INVENTION

### Field of the Invention

The present invention relates to a coil, a rotating electrical machine, a rotating electrical machine system, and a method of manufacturing a permanent magnet. Priority is claimed on Japanese Patent Application No. 2018-112849, filed on Jun. 13, 2018, and Japanese Patent Application No. 2019-021693, filed on Feb. 8, 2019, the contents of which are incorporated herein by reference.

### Description of Related Art

It is desirable that a rotating electrical machine such as generator or electrical motor rotates at a higher speed and has a smaller size.

Japanese Patent No. 5576246 discloses an axial-gap type motor in which, because a coreless design such as no core being used is adopted and a coil is adopted which is a belt-like wire rod wound spirally, losses occurring in the core can be zeroed out, and it is possible to prevent an occurrence of eddy current which is caused due to leaking fluxes being linked with the coil.

Japanese Unexamined Patent Application, First Publication No. H11-122943 discloses a system including a multiplex inverter apparatus that controls a motor via a transformer, a primary winding of which is divided into multiple sections.

### SUMMARY OF THE INVENTION

When the belt-like wire rod is spirally wound as for the coil described in Japanese Patent No. 5576246, the size of a coil end becomes large, and thus it may become difficult to adopt distributed winding. Because the coil which is a belt-like wire rod wound spirally, or a coil formed by a wire rod, for example, a litz wire such as a plurality of thin conducting wires being bundles together has a low conductor space factor, the coil and the rotating electrical machine may have a large size.

The motor disclosed in Japanese Unexamined Patent Application, First Publication No. H11-122943 requires a high drive voltage and current. For this reason, there is the problem that a large transformer becomes required, and the entire size of the system becomes large.

The present invention has been made in light of such circumstances, and is to provide a coil, a rotating electrical machine, a rotating electrical machine system, and a method of manufacturing a permanent magnet, in which a size reduction and an improvement in marketable quality can be achieved.

Configurations hereinbelow are adopted to solve the above problems.

According to a first aspect of the present invention, there is provided a coil, a plurality of which are disposed to overlap each other in an axial direction, and to have different phases around an axis. The coil includes an inner coil end portion; an outer coil end portion; and a coil slot portion. The inner coil end portion extends in a peripheral direction around the axis. The outer coil end portion is disposed closer to an outside than the inner coil end portion in a radial direction relative to the axis serving as a center, and extends in the peripheral direction. The coil slot portion extends in the radial direction, and electrically connects an end portion of the inner coil end portion in the peripheral direction with an end portion of the outer coil end portion in the peripheral direction. The inner coil end portion includes an inner notch portion that is positioned to overlap an inner coil end portion of another coil which is adjacent to the coil in the axial direction as seen in the axial direction, and that is capable of accommodating the inner coil end portion of the other coil in the axial direction. The outer coil end portion includes an outer notch portion that is positioned to overlap an outer coil end portion of the other coil which is adjacent to the coil in the axial direction as seen in the axial direction, and that is capable of accommodating the outer coil end portion of the other coil in the axial direction.

In the first aspect, the inner coil end portion includes the inner notch portion, and the outer coil end portion includes the outer notch portion. For this reason, if the plurality of coils are disposed to overlap each other in the axial direction, and to have different phases around the axis, the inner notch portion can accommodate the inner coil end portion of the other coil that is adjacent to one coil in the axial direction, and the outer notch portion can accommodate the outer coil end portion of the other coil that is adjacent thereto in the axial direction. Because an inner notch portion and an outer notch portion are formed in the other coil, when the plurality of coils overlap each other in the axial direction, the inner notch portions of the adjacent coils can accommodate each other, and the outer notch portions of the adjacent coils can accommodate each other. Therefore, it is possible to decrease the width of a coil assembly (in which the plurality of coils overlap each other) in the axial direction.

Because planar lamination portions are not disposed at a region where the inside notch portion or the outer notch portion is disposed, it is possible to prevent a decrease in a conductor space factor of the inner notch portion or the outer notch portion.

Therefore, it is possible to reduce the size of the coil ends while decreasing eddy current loss.

According to a second aspect of the present invention, the inner coil end portion of the first aspect may include a first inner notch portion and a second inner notch portion. The first inner notch portion is provided to overlap an inner coil end portion of another first coil which is adjacent to the coil on one side in the axial direction. The first inner notch portion is capable of accommodating the inner coil end portion of the first coil from one side in the axial direction. The second inner notch portion is provided to overlap an inner coil end portion of another second coil which is adjacent to the coil on the other side in the axial direction. The second inner notch portion is capable of accommodating the inner coil end portion of the second coil from the other side in the axial direction.

In the second aspect, the inner coil end portion includes the first inner notch portion and the second inner notch portion. For this reason, if the other first coil is disposed to overlap the coil on one side in the axial direction, and the other second coil is disposed to overlap the coil on the other side in the axial direction, the first inner notch portion of the coil is capable of accommodating the inner coil end portion of the other first coil. Similarly, the second inner notch portion is capable of accommodating the inner coil end portion of the other second coil. For this reason, it is possible to decrease the width of an inner coil end portion side of the coil assembly (in which the plurality of coils overlap each other) in the axial direction.

According to a third aspect of the present invention, the outer coil end portion of the first or second aspect may include a first outer notch portion and a second outer notch portion. The first outer notch portion is provided to overlap an outer coil end portion of the other first coil which is adjacent to the coil on one side in the axial direction. The first outer notch portion is capable of accommodating the outer coil end portion of the first coil from one side in the axial direction. The second outer notch portion is provided to overlap an outer coil end portion of the other second coil which is adjacent to the coil on the other side in the axial direction. The second outer notch portion is capable of accommodating the outer coil end portion of the second coil from the other side in the axial direction.

In the third aspect, the outer coil end portion includes the first outer notch portion and the second outer notch portion. For this reason, if the other first coil is disposed to overlap the coil on one side in the axial direction, and the other second coil is disposed to overlap the coil on the other side in the axial direction, the first outer notch portion of the coil is capable of accommodating the outer coil end portion of the other first coil. Similarly, the second outer notch portion is capable of accommodating the outer coil end portion of the other second coil. For this reason, it is possible to decrease the width of an outer coil end portion side of the coil assembly (in which the plurality of coils overlap each other) in the axial direction.

According to a fourth aspect of the present invention, the coil slot portion of any of the first to the third aspects may include a plurality of layers of planar lamination portions which are laminated in a direction intersecting the axis, and each of which has a thickness in the lamination direction which is less than a skin depth for a frequency of current flowing through the coil slot portion.

In the fourth aspect, the coil slot portion includes the plurality of layers of planar lamination portions that are laminated in the direction intersecting the axis. Because other coils, which are adjacent to the coil in the axial direction, have different phases, and a coreless design is adopted, fluxes occurring in the coil, which are adjacent to the other coils in the axial direction, are likely to link with the coil slot portion in the axial direction. The coil slot portion is provided with the planar lamination portions, each of which has a thickness in the lamination direction which is less than the skin depth for the frequency of current flowing through the coil slot portion. Therefore, it becomes difficult for eddy current to flow in the lamination direction of the planar lamination portions. For this reason, even though fluxes occurring due to the other coils link with the coil slot portion in the axial direction, it is possible to prevent eddy current from occurring in the lamination direction of the planar lamination portions.

According to a fifth aspect of the present invention, the planar lamination portion of any of the first to fourth aspects may extend in the same direction as an extension direction of the coil slot portion.

In the configuration of the fifth aspect, it is possible to also prevent a decrease in the rigidity of the coil slot portion while preventing an occurrence of eddy current.

According to a sixth aspect of the present invention, the inner notch portion of any of the first to fifth aspects may have a depth that is greater than or equal to half a width in the axial direction of a portion of the inner coil end portion, in which the inner notch portion is not formed. The outer notch portion may have a depth that is greater than or equal to half a width in the axial direction of a portion of the outer coil end portion, in which the outer notch portion is not formed.

In the sixth aspect, the inner notch portion has a depth that is greater than or equal to half the width in the axial direction of the portion of the inner coil end portion, in which the inner notch portion is not formed. The outer notch portion has a depth that is greater than or equal to half the width in the axial direction of the portion of the outer coil end portion, in which the outer notch portion is not formed. For this reason, if the plurality of coils overlap each other in the axial direction, inner notch portions of adjacent coils accommodate each other, and outer notch portions of the adjacent coils accommodate each other, a width of the coil assembly becomes equal to a width of one coil in the axial direction.

Therefore, it is possible to reduce the size of the coil ends even though distributed winding is adopted.

According to a seventh aspect of the present invention, the coil of any of the first to sixth aspects may further include a wire rod in which a plurality of magnetic materials independent of each other are superimposed on each other with an insulating material interposed therebetween. The wire rod may be wound multiple times in the peripheral direction around the axis.

In such configuration, because adjacent magnetic materials are electrically insulated from each other by virtue of the insulating material, it is possible to further decrease an eddy current loss, and prevent heat generation or a decrease in efficiency. Because it is possible to prevent an increase in current density, it is also possible to prevent heat generation caused by Joule heat.

According to an eighth aspect of the present invention, there is provided a coil including a wire rod in which a plurality of magnetic materials independent of each other are superimposed on each other with an insulating material interposed therebetween. The wire rod is wound multiple times in a peripheral direction around an axis.

According to a ninth aspect of the present invention, there is provided an axial-gap type rotating electrical machine. The rotating electrical machine includes a stator; a casing; a rotor; and a rotary shaft. The stator includes a plurality of coils of any of the first to seventh aspects which overlap each other in an axial direction, and have different phases around an axis. The casing covers the stator from an outside in a radial direction relative to the axis serving as a center. The rotor has a permanent magnet. The rotor is disposed to face the plurality of coils in the axial direction. The rotary shaft is supported by the casing, and capable of rotating with the rotor around the axis.

In the configuration of the ninth aspect, because it is possible to achieve a size reduction while decreasing an eddy current loss, it is possible to improve the efficiency during high-speed rotation.

According to a tenth aspect of the present invention, the casing of the ninth aspect may include a refrigerant flow path thereinside, through which a refrigerant flows, and at least part of an outer coil end portion of the stator may be disposed in the refrigerant flow path.

In the configuration of the tenth aspect, because the refrigerant is capable of directly cooling the coil, it is possible to improve cooling performance. Therefore, compared to when the coil is cooled by only air, it is possible to decrease an air flow path and an area of the coil, which is in contact with air. As a result, it is possible to reduce the size or weight of the rotating electrical machine.

According to an eleventh aspect of the present invention, a plurality of stages of the stators and a plurality of stages of the rotors of the ninth or tenth aspect may be provided to be spaced apart from each other in the axial direction.

If the plurality of stages of stators and the plurality of stages of rotors are provided to be spaced apart from each other in the axial direction, the larger the number of stages, the more the size is reduced.

According to a twelfth aspect of the present invention, the stator of any of the ninth or tenth aspect may include a mold portion supported by the casing, and the mold portion may be made of a composite material.

In such configuration, it is possible to easily adjust heat conduction, insulation properties, and heat resistance of the mold portion.

According to a thirteenth aspect of the present invention, the mold portion of the twelfth aspect may include an axial mold portion covering the coils in the axial direction, and the axial mold portion may have a groove accommodating the plurality of coils.

In such configuration, because it is possible to increase a contact area between the coil and the mold portion, it is possible to more firmly fix the mold portion to the coil.

According to a fourteenth aspect of the present invention, the axial mold portion of the thirteenth aspect may include a peripheral refrigerant flow path through which the refrigerant flows in a peripheral direction around the axis. In such a configuration, it is possible to efficiently cool the coil.

According to a fifteenth aspect of the present invention, the permanent magnet of any of the ninth to fourteenth aspects may have a plurality of magnet blocks disposed to line up in the peripheral direction around the axis, and have a ring shape around the axis. The rotor may include a torque transmission portion and an outer ring portion. The torque transmission portion presses the permanent magnet to the outside in the radial direction relative to the axis serving as a center, and transmits a rotational torque around the axis, which is applied to the permanent magnet, to the rotary shaft. The outer ring portion prevents the permanent magnet from being displaced to the outside in the radial direction when a centrifugal force is applied to the permanent magnet.

In such configuration, even though the permanent magnet is displaced or deformed to the outside in the radial direction due to centrifugal force when the rotor rotates at a high speed, because the torque transmission portion presses the permanent magnet to the outside in the radial direction, a clearance is not formed between the permanent magnet and the torque transmission portion. As a result, it is possible to prevent hinderance of torque transmission from the permanent magnet to the rotary shaft.

According to a sixteenth aspect of the present invention, the torque transmission portion of the fifteenth aspect may include a key portion; a spring portion; and a surface contact portion. The key portion is disposed in the rotary shaft or a keyway formed in an inner ring portion fixed to an outer peripheral surface of the rotary shaft, and is capable of sliding in the radial direction. The spring portion biases the key portion to the outside in the radial direction. The surface contact portion is pressed from an inside in the radial direction by the key portion, and has an outer surface, the entirety of which is in surface contact with an inner peripheral surface of the permanent magnet.

In such configuration, because the surface contact portion is biased to the outside in the radial direction, even though centrifugal force is applied to the permanent magnet, the entirety of the outer surface of the surface contact portion can remain in surface contact with the inner peripheral surface of the permanent magnet.

According to a seventeenth aspect of the present invention, the torque transmission portion of the fifteenth aspect may include an elastic bending portion and a surface contact portion. The elastic bending portion has a U-shaped spring portion capable of being compressed and deformed in the radial direction. The surface contact portion is pressed from an inside in the radial direction by the elastic bending portion, and has an outer surface, the entirety of which is in surface contact with an inner peripheral surface of the permanent magnet.

In such configuration, because the surface contact portion is biased to the outside in the radial direction, even though centrifugal force is applied to the permanent magnet, the entirety of the outer surface of the surface contact portion can remain in surface contact with the inner peripheral surface of the permanent magnet. Even though an angle of the inner peripheral surface of the permanent magnet is changed due to centrifugal force, because the U-shaped spring portion is elastically deformed, the outer surface of the surface contact portion can travel in response to a change in the angle of the inner peripheral surface. Therefore, the entirety of the outer surface of the surface contact portion is in surface contact with the inner peripheral surface of the permanent magnet, and thus it is possible to efficiently transmit a torque of the permanent magnet to the inner ring portion.

According to an eighteenth aspect of the present invention, there is provided a rotating electrical machine including a stator having a plurality of coils; a rotor having a permanent magnet, and disposed to face the plurality of coils; and a rotary shaft capable of rotating with the rotor around an axis. The permanent magnet has a plurality of magnet blocks disposed to line up in a peripheral direction around the axis, and has a ring shape around the axis. The rotor includes a torque transmission portion and an outer ring portion. The torque transmission portion presses the permanent magnet to an outside in a radial direction relative to the axis serving as a center, and transmits a rotational torque around the axis, which is applied to the permanent magnet, to the rotary shaft. The outer ring portion prevents the permanent magnet from being displaced to the outside in the radial direction when a centrifugal force is applied to the permanent magnet.

According to a nineteenth aspect of the present invention, the torque transmission portion of the eighteenth aspect may include a key portion; a spring portion; and a surface contact portion. The key portion is disposed in the rotary shaft or a keyway formed in an inner ring portion fixed to an outer peripheral surface of the rotary shaft, and is capable of sliding in the radial direction. The spring portion biases the key portion to the outside in the radial direction. The surface contact portion is pressed from an inside in the radial direction by the key portion, and has an outer surface, the entirety of which is in surface contact with an inner peripheral surface of the permanent magnet.

According to a twentieth aspect of the present invention, the torque transmission portion of the nineteenth aspect may include an elastic bending portion and a surface contact portion. The elastic bending portion has a U-shaped spring portion capable of being compressed and deformed in the radial direction. The surface contact portion is pressed from an inside in the radial direction by the elastic bending portion, and has an outer surface, the entirety of which is in surface contact with an inner peripheral surface of the permanent magnet.

According to a 21st aspect of the present invention, there is provided a rotating electrical machine system including the rotating electrical machine of the eleventh aspect. The rotating electrical machine system includes a power converter converting power generated by the rotating electrical machine. The power converter includes a plurality of converters and a plurality of inverters. Each of the plurality of converters is connected to one of the plurality of stators, and is configured to convert AC power of the stators into DC power. Each of the plurality of inverters is connected to one of the plurality of converters, and is configured to convert DC power of the converters into AC power. Output terminals of a plurality of the inverters outputting the same phase of AC power are connected together in series.

In the configuration of the 21st aspect, a power is converted into a DC power by a converter for each of the plurality of stages of stators, and then the DC power is converted into an AC power by an inverter. Because output terminals of the plurality of inverters outputting the same phase of AC power are connected together in series, it is possible to further increase a voltage in proportional to the number of the inverters being connected together in series. It is possible to obtain power at a desired frequency via the inverters regardless of a rotational speed of the rotating electrical machine.

Therefore, because it is possible to use converters or inverters with a low rated voltage compared to when a power output of the rotating electrical machine is converted by one converter or one inverter, it is possible to reduce component costs. Moreover, because it is possible to divide and take out the entire output voltage of the rotating electrical machine without using a transformer, it is possible to decrease the number of components by virtue of the transformer being omitted.

According to a 22nd aspect of the present invention, the converter of the 21st aspect may be provided for each coil of the stator, and convert a single-phase AC power, which is outputted from one coil, into DC power.

In the configuration of the 22nd aspect, it is possible to obtain a desired number of phases of AC power without restriction to the number of stages of the stators of the rotating electrical machine.

According to a 23rd aspect of the present invention, one converter of the 21st aspect may be provided for each stage of the stators, and convert a multiple-phase AC power, which is outputted from each stage of the stators, into DC power.

In the configuration of the 23rd aspect, because the converter and the inverter may be provided for each of the stators, when the rotating electrical machine has a large number of the stators, it is possible to prevent an increase in the number of components.

According to a 24th aspect of the present invention, there is provided a rotating electrical machine system including a generator in which each phase of a coil has a plurality of divided coils, and a power converter converting a power generated by the generator. The power converter includes converters and inverters. One converter is connected with each of the divided coils, and is configured to convert an AC power of the divided coil into a DC power. Each of the plurality of inverters is connected to one of the plurality of converters, and convert DC power of the converters into AC power. Output terminals of a plurality of the inverters outputting the same phase of AC power are connected together in series.

In the 24th aspect, a power output of the coil is converted into DC power by a converter for each of the divided coils, and then the DC power is converted into AC power by an inverter. Because output terminals of the plurality of inverters outputting the same phase of AC power are connected together in series, it is possible to further increase a voltage in proportional to the number of the inverters being connected together in series. It is possible to obtain power at a desired frequency via the inverters regardless of a rotational speed of the rotating electrical machine.

According to a 25th aspect of the present invention, there is provided a rotating electrical machine system including a generator provided with a plurality of layers of multiple-phase coils, and a power converter converting a power generated by the generator. The power converter includes converters and inverters. One converter is provided for each layer, and converts a multiple-phase AC power, which is outputted from each layer of the multiple-phase coils, into DC power. Each of the plurality of inverters is connected to one of the plurality of converters, and is configured to convert DC power of the converters into AC power. Output terminals of a plurality of the inverters outputting the same phase of AC power are connected together in series.

In the 25th aspect, power output of the coil is converted into DC power by a converter for each layer including the multiple-phase coils, and then the DC power is converted into AC power by an inverter. Because output terminals of the plurality of inverters outputting the same phase of AC power are connected together in series, it is possible to further increase voltage in proportional to the number of the inverters being connected together in series. It is possible to obtain power at a desired frequency via the inverters regardless of the rotational speed of the rotating electrical machine.

In the 24th and 25th aspects, because it is possible to use converters or inverters with a low rated voltage compared to when a power output of the rotating electrical machine is converted by one converter or one inverter, it is possible to reduce component costs. Moreover, because it is possible to divide and take out the entire output voltage of the rotating electrical machine without using a transformer, it is possible to decrease the number of components by virtue of the transformer being omitted.

According to a 26th aspect of the present invention, there is provided a method of manufacturing a permanent magnet used in the rotating electrical machine of any of the ninth to twentieth aspects, the method including setting upper limit values for each of an eddy current loss and a magnet cost; and determining the number of divisions of the permanent magnet in a peripheral direction or a radial direction relative to an axis serving as a center within a range where the eddy current loss and the magnet cost do not exceed the upper limit values, according to a relationship between the eddy current loss and the number of divisions of the permanent magnet, and a relationship between the magnet cost and the number of divisions of the permanent magnet. In such a configuration, it is possible to optimize the number of divisions of the permanent magnet in one of the peripheral direction and the radial direction so as to satisfy product requirements (efficiency and cost) of the rotating electrical machine.

According to a 27th aspect of the present invention, there is provided a method of manufacturing a permanent magnet used in the rotating electrical machine of any of the ninth to twentieth aspects, the method including setting upper limit values for each of an eddy current loss and a magnet cost; and determining a magnet aspect ratio of each of a plurality of magnet blocks of the permanent magnet within a range where the eddy current loss and the magnet cost do not exceed the upper limit values, according to a relationship between the eddy current loss and the magnet aspect ratio, and a relationship between the magnet cost and the magnet aspect ratio.

When the permanent magnet is divided in both of the peripheral direction and the radial direction, it is possible to optimize the magnet aspect ratio of the magnet block of the permanent magnet so as to satisfy the product requirements (efficiency and cost) of the rotating electrical machine.

According to a 28th aspect of the present invention, there is provided a method of manufacturing a permanent magnet used in a rotating electrical machine, the method including setting upper limit values for an eddy current loss and a magnet cost; and determining the number of divisions of the permanent magnet in a peripheral direction or a radial direction relative to an axis serving as a center within a range where the eddy current loss and the magnet cost do not exceed the upper limit values, according to a relationship between the eddy current loss and the number of divisions of the permanent magnet, and a relationship between the magnet cost and the number of divisions of the permanent magnet.

According to a 29th aspect of the present invention, there is provided a method of manufacturing a permanent magnet used in a rotating electrical machine, the method including setting upper limit values for an eddy current loss and a magnet cost; and determining a magnet aspect ratio of each of a plurality of magnet blocks of the permanent magnet within a range where the eddy current loss and the magnet cost do not exceed the upper limit values, according to a relationship between the eddy current loss and the magnet aspect ratio, and a relationship between the magnet cost and the magnet aspect ratio.

In to the coil, the rotating electrical machine, the rotating electrical machine system, and the method of manufacturing a permanent magnet, it is possible to achieve a size reduction.

### BRIEF DESCRIPTION OF THE DRAWINGS

FIG. 1 is a configuration view showing a schematic configuration of a generator according to a first embodiment of the present invention.

FIG. 2 is a view of a stator as viewed in an axial direction according to the first embodiment of the present invention.

FIG. 3 is a view of a coil of one phase as viewed in the axial direction according to the first embodiment of the present invention.

FIG. 4 is a perspective view showing one winding portion of the coil according to the first embodiment of the present invention.

FIG. 5 is a diagram showing a schematic configuration of a power converter according to the first embodiment of the present invention.

FIG. 6 is a magnified cross-sectional view of a coil including an axis according to a second embodiment of the present invention.

FIG. 7 is a cross-sectional view of a refrigerant flow path perpendicular to the axis according to the second embodiment of the present invention.

FIG. 8 is a diagram of a power converter according to the third embodiment of the present invention, which is equivalent to FIG. 5.

FIG. 9 is a view showing a schematic configuration of a stator of a generator according to a fourth embodiment of the present invention.

FIG. 10 is a diagram showing an equivalent circuit of a coil according to the fourth embodiment of the present invention.

FIG. 11 is a diagram showing a schematic configuration of a power converter according to the fourth embodiment of the present invention.

FIG. 12 is a diagram showing an equivalent circuit of a coil according to a fifth embodiment of the present invention.

FIG. 13 is a diagram of a power converter according to the fifth embodiment of the present invention, which is equivalent to FIG. 11.

FIG. 14 is a view of a sixth embodiment of the present invention, which is equivalent to FIG. 3.

FIG. 15 is a magnified view of a wire rod according to the sixth embodiment of the present invention.

FIG. 16 is a cross-sectional view of a stator according to a seventh embodiment of the present invention.

FIG. 17 is a view as seen in a direction XVII of FIG. 16.

FIG. 18 is a view of a stator unit as seen in the direction XVII of FIG. 16.

FIG. 19 is a cross-sectional view of an axial mold portion according to the seventh embodiment of the present invention.

FIG. 20 is a cross-sectional view of a rotor according to an eighth embodiment of the present invention.

FIG. 21 is a view of the rotor as viewed in the axial direction according to the eighth embodiment of the present invention.

FIG. 22 is a cross-sectional view of a torque transmission portion according to a modification example of the eighth embodiment of the present invention.

FIG. 23 is a graph with eddy current loss and magnet cost on the vertical axis, and the number of divisions of a magnet on the horizontal axis.

FIG. 24 is a graph with eddy current loss and magnet cost on the vertical axis, and magnet aspect ratio on the horizontal axis.

### DETAILED DESCRIPTION OF THE INVENTION

Subsequently, coils, rotating electrical machines, and rotating electrical machine systems according to embodiments of the present invention will be described with reference to the drawings.

### First Embodiment

A rotating electrical machine system according to a first embodiment of the present invention includes a rotating electrical machine and a power converter. The rotating electrical machine of the first embodiment is an axial-gap type generator. The generator of the first embodiment is an AC generator used in wind power generation, hydroelectric power generation, or the like. The rotating electrical machine may be a motor generator.

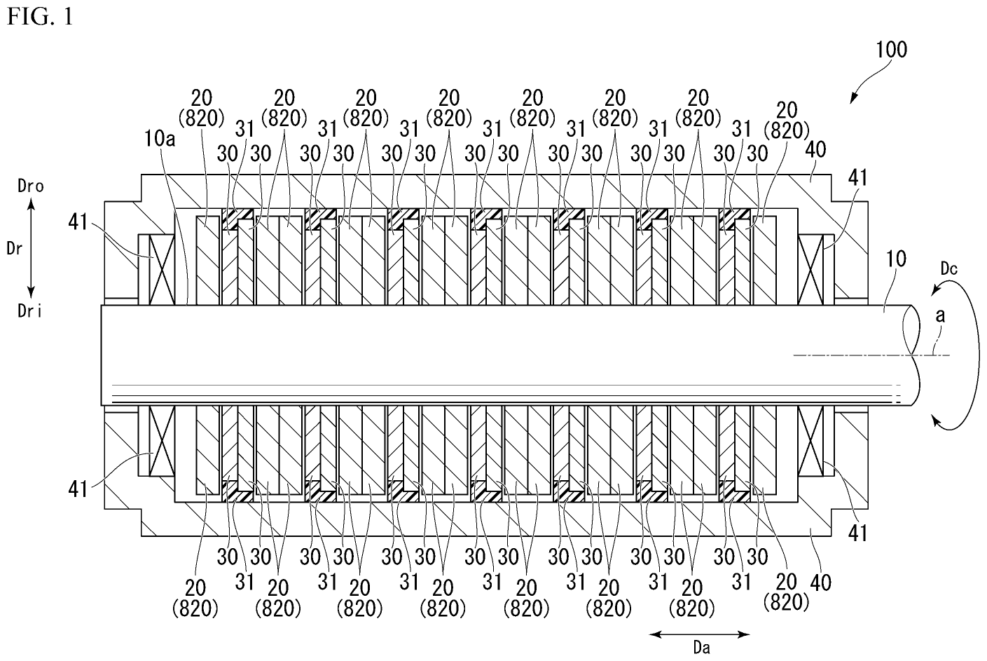

FIG. 1 is a configuration view showing a schematic configuration of the generator according to the first embodiment of the present invention.

As shown in FIG. 1, a generator 100 of the first embodiment includes a rotary shaft 10; a rotor 20; a stator 30; and a casing 40. The rotary shaft 10 can rotate around an axis a while being supported by the casing 40. Rotational energy is input to the rotary shaft 10 from a drive source such as turbine or windmill. The rotary shaft 10 has a round hollow tubular shape through which cooling air passes.

The rotor 20 extends from an outer peripheral surface 10a of the rotary shaft 10 to an outside (hereinbelow, simply referred to as a radial outside Dro) in a radial direction Dr relative to the axis a serving as a center. That is, the rotor 20 can rotate with the rotary shaft 10 around the axis a. The rotor 20 provided as an exemplary example in the first embodiment has a circular disc shape having the axis a as a center, and has a permanent magnet (not shown) in a center portion (center portion in the radial direction Dr) of the rotor 20. In the generator 100 of the embodiment, a plurality of stages of the rotors 20 are provided to be spaced apart from each other in an axial direction Da. A reinforcement material may be disposed in the rotor 20 while being closer to the radial outside Dro than the permanent magnet, and serve as a reinforcement member against centrifugal force applied when the rotor 20 rotates.

The stator 30 is disposed to face the rotor 20 and be spaced apart by a small clearance from the rotor 20 in the axial direction Da. That is, similar to the rotor 20, a plurality of stages of the stators 30 are provided to be spaced apart from each other in the axial direction Da. According to a disposition of the stators 30 and the rotors 20 of the embodiment, two rotors 20 in the axial direction Da are interposed between two stators 30 on outsides in the axial direction Da. The stator 30 is supported via a mold portion 31 by the casing 40. The stator 30 includes a plurality of coils 32 (details will be described later) that overlap each other in the axial direction Da and have different phases around the axis a. The coils 32 are so-called coreless-type coils, and the permanent magnet of the rotor 20 is disposed to face the coils 32.

The casing 40 covers the stator 30 and the rotor 20 from the radial outside Dro. The casing 40 of the embodiment has a round tubular shape having both closed end portions in the axial direction Da, in other words, has a round hollow tubular shape. Bearings 41 are provided at both end portions of the casing 40 in the axial direction Da, and rotatably support the rotary shaft 10.

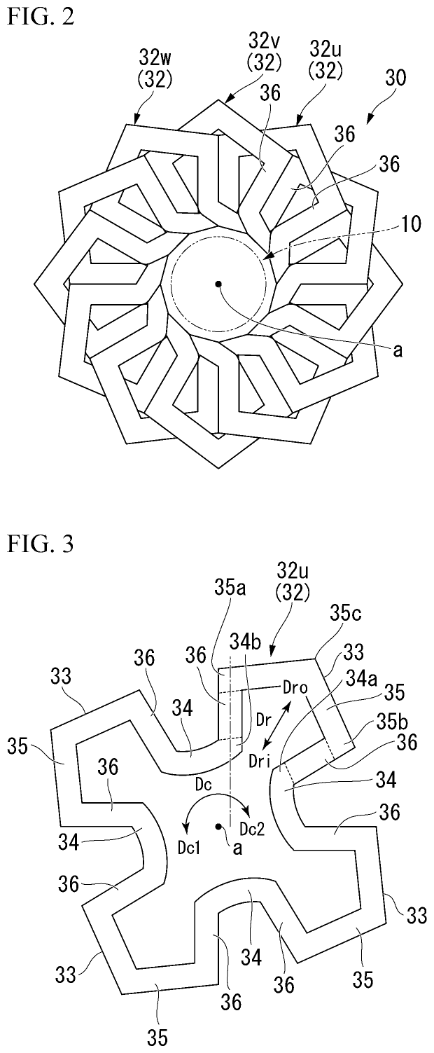

FIG. 2 is a view of the stator as viewed in the axial direction according to the first embodiment of the present invention. FIG. 3 is a view of a coil of one phase as viewed in the axial direction according to the first embodiment of the present invention.

As shown in FIGS. 2 and 3, one stator 30 of the first embodiment includes three-phase coils 32u, 32v, and 32w as the coils 32. The three-phase coils 32u, 32v, and 32w are made of metal such as copper, and have the same shape. The three-phase coils 32u, 32v, and 32w are disposed to overlap each other in the axial direction Da (direction of the front and back surfaces of FIG. 2). Phases of the three-phase coils 32u, 32v, and 32w around the axis a differ from each other. In the first embodiment, the phases differ from each other by 30 degrees. Insulating coatings are formed on back surfaces of the coils 32u, 32v, and 32w, and thus the coils 32u, 32v, and 32w are electrically insulated from each other. In a description hereinbelow, when it is not necessary to differentiate phases of the coils 32u, 32v, and 32w from each other, the coils 32u, 32v, and 32w may be simply and collectively referred to as the coil 32.

As shown in FIG. 3, the coil 32 of one phase includes four winding portions 33 that protrude to the radial outside Dro relative to the axis a serving as a center. Four winding portions 33 are provided every 90 degrees in a peripheral direction Dc around the axis a. In FIGS. 2 and 3, for illustrative purposes, end portions of the coil 32 are not shown, but the coil 32 have the end portions on both sides in the peripheral direction. Lead wires (not shown) are connected to the end portions. The power converter which will be described later is connected to end portions of the lead wires. In the embodiment, a method of winding the coil 32 of the stator 30 is a coreless method, and winding is distributed over a plurality of slots, and is wave winding.

The coil 32 includes an inner coil end portion 34; an outer coil end portion 35; and a coil slot portion 36.

The inner coil end portion 34 extends in the peripheral direction Dc. In the coil 32, the inner coil end portion 34 is disposed closest to the axis a. In the embodiment, four inner coil end portions 34 are provided, and are disposed to be equally spaced apart from each other in the peripheral direction Dc. The inner coil end portion 34 which is an exemplary example in the embodiment has a curved shape that is convex to a radial inside Dri as viewed in the axial direction Da. The inner coil end portion 34 has a rectangular cross section perpendicular to the extension direction of the inner coil end portion 34.

The outer coil end portion 35 is disposed closer to the radial outside Dro than the inner coil end portion 34. The outer coil end portion 35 extends in the peripheral direction Dc. In the embodiment, four outer coil end portions 35 are provided, and are disposed to be equally spaced apart from each other in the peripheral direction Dc. As viewed from the radial outside Dro, an end portion 35a of the outer coil end portion 35 which is on a first peripheral side Dc1 is disposed to overlap an end portion 34b of the inner coil end portion 34 which is on a second peripheral side Dc2.

Similarly, as viewed from the radial outside Dro, an end portion 35b of the outer coil end portion 35 which is on the second peripheral side Dc2 is disposed to overlap an end portion 34a of the inner coil end portion 34 which is on the first peripheral side Dc1. The outer coil end portion 35 which is an exemplary example in the embodiment has an L shape in which an angulated portion 35c is disposed in a center portion (center portion in the peripheral direction Dc) of the outer coil end portion 35 as seen in the axial direction Da. Similar to the inner coil end portion 34, the outer coil end portion 35 has a rectangular cross section perpendicular to the extension direction of the outer coil end portion 35. The cross-sectional shape of the outer coil end portion 35 is not limited to the rectangular shape.

The coil slot portion 36 extends in the radial direction Dr, electrically connects the end portion 34a of the inner coil end portion 34 with the end portion 35b of the outer coil end portion 35, and electrically connects the end portion 34b of the inner coil end portion 34 with the end portion 35a of the outer coil end portion 35. The coil slot portion 36 of the first embodiment extends straight in the radial direction Dr.

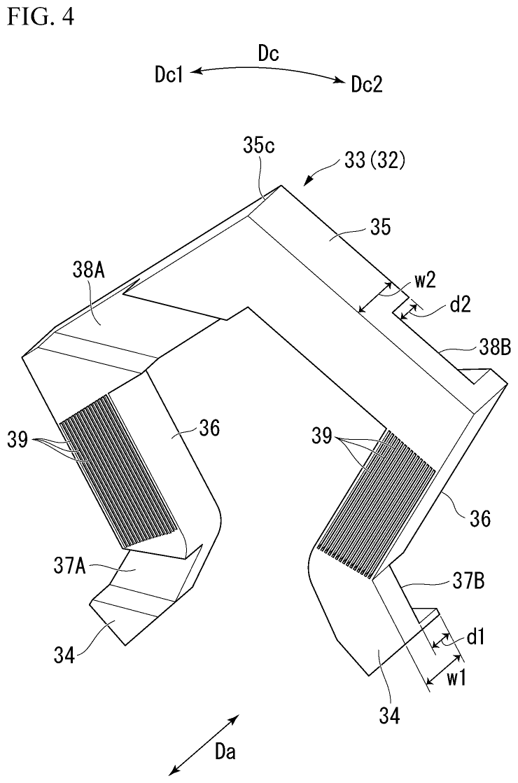

FIG. 4 is a perspective view showing one winding portion of the coil according to the first embodiment of the present invention. As shown in FIG. 4, the inner coil end portion 34 of one coil 32 includes an inner notch portion 37A (first inner notch portion 37A) and an inner notch portion 37B (second inner notch portion 37B) at positions (refer to FIG. 2) where, as viewed in the axial direction Da, the inner coil end portion 34 overlaps the inner coil end portions 34 of other phase coils 32 that are adjacent to one coil 32 in the axial direction Da. If the coil 32 shown in FIG. 4 is the coil 32v, the other phase coils 32 are equivalent to the coil 32u (another first coil 32u) and the coil 32w (another second coil 32w) (refer to FIG. 2).

The inner coil end portions 34 of the other phase coils 32 are accommodated in the axial direction Da by the inner notch portions 37A and 37B. Each of the inner notch portions 37A and 37B provided as an exemplary example in the embodiment is an angulated groove having a width slightly greater than a width of each of the inner coil end portions 34 of the other phase coils 32. A depth d1 of each of the inner notch portions 37A and 37B is greater than or equal to half a width w1 (a length of the width w1 in the axial direction Da) of a portion of the inner coil end portion 34, in which the inner notch portions 37A and 37B are not formed. In the embodiment, the depth d1 of each of the inner notch portions 37A and 37B is half the width w1 in the axial direction Da.

Similar to the inner coil end portion 34, the outer coil end portion 35 of one coil 32 includes an outer notch portion 38A (first outer notch portion 38A) and an outer notch portion 38B (second outer notch portion 38B) at positions (refer to FIG. 2) where, as viewed in the axial direction Da, the outer coil end portion 35 overlaps the outer coil end portions 35 of other phase coils 32 that are adjacent to one coil 32 in the axial direction Da. The outer coil end portions 35 of the other phase coils 32 are accommodated in the axial direction Da by the outer notch portions 38A and 38B. Similar to the inner notch portions 37A and 37B, each of the outer notch portions 38A and 38B provided as exemplary examples in the embodiment is an angulated groove having a width slightly greater than a width of each of the outer coil end portions 35 of the other phase coils 32. A depth d2 of each of the outer notch portions is greater than or equal to half a width w2 (a length of the width w2 in the axial direction Da) of a portion of the outer coil end portion 35, in which the outer notch portions 38A and 38B are not formed. In the embodiment, the depth d2 of each of the outer notch portions is half the width w2 in the axial direction Da, and the width w1 is equal to the width w2.

In the example of one winding portion 33 of the coil 32v, the inner notch portion 37A accommodating the inner coil end portion 34 of the coil 32u, and the outer notch portion 38A accommodating the outer coil end portion 35 of the coil 32u are provided on the first peripheral side Dc1 of the winding portion 33. The inner notch portion 37B accommodating the inner coil end portion 34 of the coil 32w, and the outer notch portion 38B accommodating the outer coil end portion 35 of the coil 32w are provided on the second peripheral side Dc2.

That is, two inner notch portions 37A and 37B and two outer notch portions 38A and 38B are formed in one winding portion 33 of the coil 32. Two inner notch portions 37A and 37B open to face opposite sides in the axial direction Da, and similarly, two outer notch portions 38A and 38B open to face opposite sides in the axial direction Da.

Therefore, because the coil 32u, the coil 32v, and the coil 32w overlap each other in the axial direction Da, the inner notch portions 37A and 37B of the adjacent coils 32 face and accommodate each other, and the outer notch portions 38A and 38B of the adjacent coils 32 face and accommodate each other. For this reason, it is possible to decrease a width (a length of the width in the axial direction Da) of the stator 30, which is a coil assembly where the coils 32u, 32v, and 32w overlap each other, to approximately a width of one coil 32 in the axial direction Da.

The coil slot portion 36 includes a plurality of planar lamination portions 39. The plurality of planar lamination portions 39 are laminated in a direction intersecting the axis. The planar lamination portion 39 is made of the same metal, for example, copper as the outer coil end portion 35 or the inner coil end portion 34. The thickness of the planar lamination portion 39 in a direction (hereinbelow, simply referred to as lamination direction), in which the planar lamination portions 39 are laminated, is less than a skin depth for the frequency of current flowing through the coil slot portion 36. It is possible to obtain a skin depth d via d=(2 ρ/ωμ)^{1/2}. ω represents angular velocity, ρ represents conductivity, and μ represents permeability. The planar lamination portion 39 of the first embodiment has a belt-like shape having a constant width and a constant thickness.

The stator 30 is a coreless-type stator not having a core such as iron core. The permeability of copper, of which the coil 32 is made, is equal to the permeability of air. For this reason, the coil slot portion 36 of the coil 32, which is disposed as shown in FIG. 2, is likely to link with fluxes occurring due to other phase coils 32 that are adjacent to the coil 32 in the axial direction Da. Because the magnitude of eddy current occurring due to the fluxes being linked with the coil is proportional to a plate thickness, it is possible to lower the eddy current occurring due to the linked fluxes by laminating together the plurality of planar lamination portions 39, the thickness of which is less than the skin depth d. The planar lamination portion 39 provided as an exemplary example in the embodiment extends in the radial direction Dr which is the extension direction of the coil slot portion 36. The extension direction of the planar lamination portion 39 may be a direction intersecting the axial direction Da in which the fluxes link with the coil.

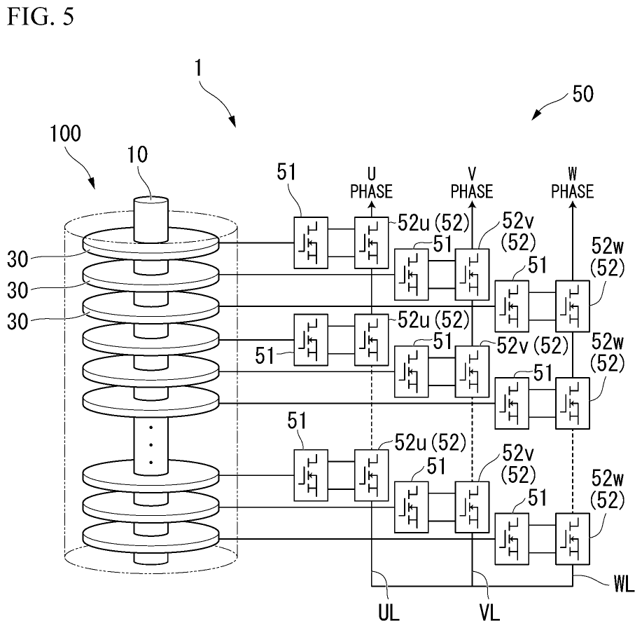

FIG. 5 is a diagram showing a schematic configuration of the power converter according to the first embodiment of the present invention.

As shown in FIG. 5, a rotating electrical machine system 1 of the first embodiment includes the rotating electrical machine 100 and a power converter 50. The power converter 50 includes a plurality of converters 51 and a plurality of inverters 52. The power converter 50 converts power generated by the generator. The power converter 50 of the embodiment outputs AC power, which is generated by the generator, in the form of a three-phase AC power at a commercial frequency (for example, 50 Hz or 60 Hz in Japan).

The converter 51 is connected with each of the plurality of stators 30. In other words, the plurality of converters 51 are each connected to one of the different stages of the stators 30. The converter 51 converts an AC power of the stator 30 into a DC power. More specifically, one converter 51 is provided for each stage of the stators 30. The converter 51 converts a three-phase AC power, which is outputted from each stage of the stators 30, into a DC power. That is, a three-phase AC power outputted from the coils 32u, 32v, and 32w is converted into one DC power. A rectifier circuit in which diodes are used, or a bridge circuit built from switching elements can be used as the converter 51.

The inverters 52 are each connected to one of the plurality of converters 51. In other words, one inverter 52 is connected with one converter 51. The inverter 52 converts DC power of the converter 51 into AC power. Output terminals of a plurality of the inverters 52 outputting the same phase of AC power are connected together in series.

More specifically, output terminals of a plurality of inverters 52u outputting a U-phase AC power are connected together in series, output terminals of a plurality of inverters 52v outputting a V-phase AC power are connected together in series, and output terminals of a plurality of inverters 52w outputting a W-phase AC power are connected together in series. In the embodiment, a U-phase power line UL through which the inverters 52u are connected together in series, a V-phase power line VL through which the inverters 52v are connected together in series, and a W-phase power line WL, through which the inverters 52w are connected together in series, are connected together via Y connection in which the U-phase power line UL, the V-phase power line VL, and the W-phase power line WL are connected together via a neutral point. The connection form is not limited to the Y connection, and other connection forms may be adopted. In a description hereinbelow, when it is not necessary to differentiate phases of the inverters 52u, 52v, and 52w from each other, the inverters 52u, 52v, and 52w may be simply and collectively referred to as the inverter 52.

In the embodiment, the number of the inverters 52u outputting a U-phase AC power, the number of the inverters 52v outputting a V-phase AC power, and the number of the inverters 52w outputting a W-phase AC power are the same. The inverters 52 outputting each phase of AC power is PWM controlled by a controller which is not shown. If n number of the inverters 52 outputting each phase of AC power are connected together in series, PWM control periods of the inverters 52 may be shifted from each other by a 1/n period to rectify a waveform of each phase of AC power. A reactor may be connected to rectify a waveform of each phase of AC power. The installation number of the converters 51 or the installation number of the inverters 52 is not limited to the installation number described above. When a rated current of the converter 51 or the inverter 52 is low, a plurality of the converters 51 or a plurality of the inverters 52 may be appropriately connected together in parallel.

In the embodiment, because other coils 32, which are adjacent to the coil 32 in the axial direction Da, have different phases, and a coreless design is adopted, fluxes occurring in the coil 32, which are adjacent to the other coils 32 in the axial direction Da, are likely to link with the coil slot portion 36 in the axial direction Da. The coil slot portion 36 includes the plurality of layers of planar lamination portions 39 that are laminated in the direction intersecting the axis a. Moreover, the thickness of the planar lamination portion 39 in the lamination direction is less than the skin depth d for the frequency of current flowing through the coil slot portion 36. Therefore, it becomes difficult for eddy current to flow in the lamination direction of the planar lamination portions 39. For this reason, even though fluxes occurring due to the other coils 32 link with the coil slot portion 36 in the axial direction Da, it is possible to prevent an occurrence of eddy current.

In the first embodiment, the inner coil end portion 34 includes the inner notch portions 37A and 37B, and the outer coil end portion 35 includes the outer notch portions 38A and 38B. For this reason, if the plurality of coils 32 are disposed to overlap each other in the axial direction Da, and to have different phases around the axis a, the inner notch portions 37A and 37B can accommodate the inner coil end portions 34 of other coils 32 that are adjacent to one coil 32 in the axial direction Da, and the outer notch portions 38A and 38B can accommodate the outer coil end portions 35 of the other coils 32 that are adjacent thereto in the axial direction Da. Because the inner notch portions 37A and 37B and the outer notch portions 38A and 38B are formed in the other coils 32, when the plurality of coils 32 overlap each other in the axial direction Da, the inner notch portions 37A and 37B of the adjacent coils 32 can accommodate each other, and the outer notch portions 38A and 38B of the adjacent coils 32 can accommodate each other. Therefore, it is possible to decrease the width of a coil assembly (in which the plurality of coils overlap each other) in the axial direction Da.

In the first embodiment, the planar lamination portions 39 are not disposed at locations where the inner notch portions 37A and 37B or the outer notch portions are disposed. For this reason, it is possible to prevent a decrease in a conductor space factor of the inner notch portions 37A and 37B or the outer notch portions 38A and 38B. Because the inner coil end portion 34 and the outer coil end portion 35 are not disposed at locations where fluxes are likely to link therewith, even though the inner coil end portion 34 and the outer coil end portion 35 do not have the planar lamination portion 39, the influence of eddy current is negligible.

Therefore, it is possible to reduce the size of the coil ends of the stator 30 while decreasing eddy current loss. It is possible to improve the efficiency of the generator 100 during high-speed rotation.

In the first embodiment, the planar lamination portion 39 extends in the same direction as the extension direction of the coil slot portion 36. For this reason, it is possible to also prevent a decrease in the rigidity of the coil slot portion 36 while preventing an occurrence of eddy current.

In the first embodiment, because each of the inner notch portions 37A and 37B has a depth that is greater than or equal to half the width (the length of the width in the axial direction Da) of a portion of the inner coil end portion 34, in which the inner notch portions 37A and 37B are not formed, the width (the length of the width in the axial direction Da) of the stator 30 which is a coil assembly can be made equal to the width (the length of the width in the axial direction Da) of one coil.

Therefore, it is possible to reduce the size of the coil ends of the stator 30 even though distributed winding is adopted.

In the first embodiment, because the plurality of stages of stators 30 and the plurality of stages of rotors 20 are provided in the axial direction Da, the more the number of stages of the stators 30 is, the further the size of the generator 100 is reduced.

In the first embodiment, the converters 51 are each connected to one of the plurality of stators 30, and convert AC powers of the stators 30 into DC powers. The inverters 52 are each connected to one of the plurality of converters 51, and convert DC powers of the converters 51 into AC powers. Output terminals of the plurality of inverters 52 outputting the same phase of AC power are connected together in series. For this reason, it is possible to further increase an output voltage of the power converter 50 in proportional to the number of the inverters 52 being connected together in series. It is possible to obtain power at a desired frequency via the inverters 52 regardless of a rotational speed of the generator 100.

Therefore, because it is possible to use the converters 51 or the inverters 52 with a low rated voltage compared to when a power output of the generator 100 is converted by one converter or one inverter, it is possible to reduce component costs. Moreover, because it is possible to divide and take out the entire output voltage of the generator 100 without using a transformer, it is possible to decrease the number of components by virtue of the transformer being omitted.

In the first embodiment, one converter 51 is provided for each stage of the stators 30. The converter 51 converts a three-phase AC power, which is outputted from each stage of the stator 30, into a DC power. Because the converter 51 and the inverter 52 may be provided for each of the stators 30, when the generator 100 has a large number of the stators 30, it is possible to prevent an increase in the number of components compared to when AC-to-DC conversion is performed for each phase of the coil 32. Because the stators 30, with which the inverters 52 having the same phase are connected via the converters 51, are physically apart from each other, it is not necessary to apply electrical insulation between the coils 32 of the stators 30.

### Second Embodiment

Subsequently, a second embodiment of the present invention will be described with reference to the drawings. A rotating electrical machine of the second embodiment has a cooling structure in which coils are cooled via a refrigerant, in addition to the configuration of the rotating electrical machine of the first embodiment. For this reason, a description will be provided with the same reference signs being assigned to the same elements as in the first embodiment, and duplicated descriptions will be omitted.

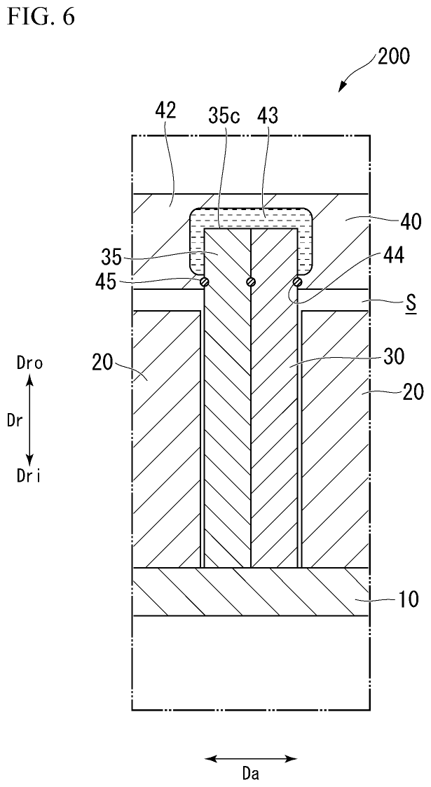

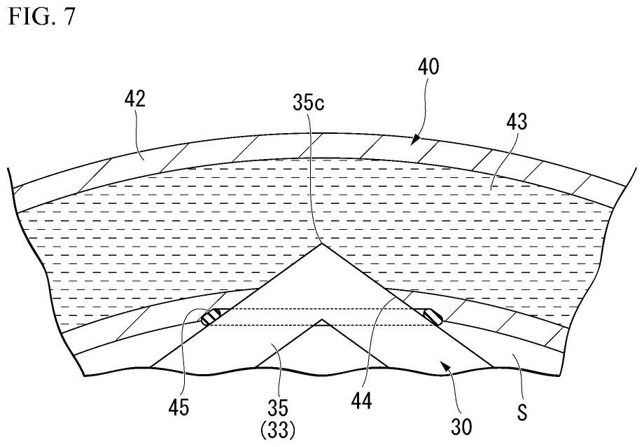

FIG. 6 is a magnified cross-sectional view of a coil including an axis according to the second embodiment of the present invention. FIG. 7 is a cross-sectional view of a refrigerant flow path perpendicular to the axis according to the second embodiment of the present invention.

Similar to the generator 100 of the first embodiment, a generator 200 of the second embodiment also is an axial-gap type AC generator. Similar to the first embodiment, the generator 200 may be a motor generator.

As shown in FIGS. 6 and 7, similar to the generator 100 of the first embodiment, the generator 200 (rotating electrical machine 200) of the second embodiment also includes the rotary shaft 10; the rotor 20; the stator 30; and the casing 40.

The casing 40 covers the stator 30 and the rotor 20 from the radial outside Dro. The casing 40 of the second embodiment includes a refrigerant flow path 43 on an inside of an outer peripheral portion 42 extending in the axial direction Da. At least part of the refrigerant flow path 43 is disposed on a side (facing the radial outside Dro) of the stator 30. The refrigerant flow path 43 of the second embodiment has an annular shape which is positioned on the side (facing the radial outside Dro) of each of the plurality of stators 30. The refrigerant such as cooling water is supplied from a refrigerant supply apparatus (not shown) to the refrigerant flow path 43. The shape of the refrigerant flow path 43 is not limited to an annular shape.

The casing 40 includes through holes 44 that communicate the refrigerant flow path 43 with an inner space S of the casing 40, in which the rotor 20 and the like are disposed. While being spaced apart from each other in the peripheral direction Dc, the through holes 44 are formed at the same positions where the coils 32 are disposed in the peripheral direction Dc. More specifically, the through holes 44 are formed at the same positions in the peripheral direction Dc as the positions of centers of a plurality of the outer coil end portions 35, at which the angulated portions 35c of the coils 32 are formed.

The stator 30 has the same configuration as in the first embodiment except that the stator 30 has a diameter greater than an inner diameter of the casing 40. At least part of the outer coil end portion 35 of the stator 30 passes through the through hole 44, and is disposed in the refrigerant flow path 43. An O-ring 45 is interposed between an inner peripheral surface of the through hole 44 and an outer peripheral surface of the outer coil end portion 35 passing through the through hole 44, and prevents the refrigerant from leaking from a clearance between the inner peripheral surface of the through hole 44 and the outer coil end portion 35. Because such a configuration is adopted, the refrigerant can directly cool the outer coil end portion 35.

Therefore, in the second embodiment, the refrigerant flowing through the refrigerant flow path 43 can directly cool the outer coil end portion 35. For this reason, it is possible to improve the performance of cooling the entirety of the coil 32 via heat conduction. If the generator 200 is designed to have the same cooling performance as when the coil 32 is cooled by only air, it is possible to decrease an air flow path inside the casing 40, and decrease an area of the coil 32, which is in contact with air. As a result, it is possible to reduce the size or weight of the generator 200.

### Third Embodiment

Subsequently, a third embodiment of the present invention will be described with reference to the drawings. The configuration of a power converter is the only difference between a rotating electrical machine of the third embodiment and that of the first embodiment. For this reason, a description will be provided with the same reference signs being assigned to the same elements as in the first embodiment, and duplicated descriptions will be omitted.

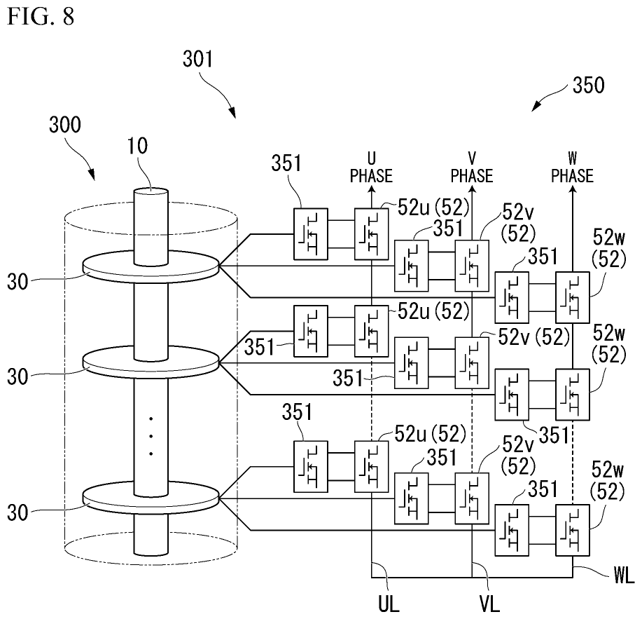

FIG. 8 is a diagram of a power converter according to the third embodiment of the present invention, which is equivalent to FIG. 5.

As shown in FIG. 8, a rotating electrical machine system 301 of the third embodiment includes a generator 300 and a power converter 350. The power converter 350 includes a plurality of converters and a plurality of inverters. The power converter 350 converts power that is generated by the generator 300 of the same axial-gap type as in the first embodiment. The power converter 350 of the embodiment outputs an AC power, which is generated by the generator 300, in the form of a three-phase (U-phase, V-phase, and W-phase in FIG. 8) AC power at a commercial frequency (for example, 50 Hz or 60 Hz in Japan).

Converters 351 are each connected to the coils 32 of each of a plurality of stages of the stators 30. The converter 351 converts a single-phase AC power, which is outputted from one coil 32, into a DC power. More specifically, three converters 351 are provided for one stator 30. In other words, single-phase AC powers outputted from the coils 32u, 32v, and 32w are converted into three DC powers. A rectifier circuit in which diodes are used, or a bridge circuit built from switching elements can be used as the converter 351.

The inverters 52 are each connected to one of the a plurality of the converters 351. That is, the inverter 52 has the same configuration as in the first embodiment, and one inverter 52 is connected with one converter 351. The inverter 52 converts a DC power of the converter 351 into an AC power. Among a plurality of the inverters 52, output terminals of a plurality of the inverters 52 outputting the same phase of AC power are connected together in series. More specifically, output terminals of a plurality of the inverters 52u outputting a U-phase AC power are connected together in series, output terminals of a plurality of the inverters 52v outputting a V-phase AC power are connected together in series, and output terminals of a plurality of the inverters 52w outputting a W-phase AC power are connected together in series. Similar to the first embodiment, the U-phase power line UL through which the inverters 52u are connected together in series, the V-phase power line VL through which the inverters 52v are connected together in series, and the W-phase power line WL, through which the inverters 52w are connected together in series, are connected together via Y connection in which the U-phase power line UL, the V-phase power line VL, and the W-phase power line WL are connected together via a neutral point. The connection form is not limited to the Y connection, and other connection forms may be adopted.

In the third embodiment, similar to the first embodiment, the number of the inverters 52u outputting a U-phase AC power, the number of the inverters 52v outputting a V-phase AC power, and the number of the inverters 52w outputting a W-phase AC power are the same. The inverters 52 are PWM controlled by a controller which is not shown. Also in the third embodiment, similar to the first embodiment, if n number of the inverters 52 are connected together in series, PWM control periods of the inverters 52 may be shifted from each other by a 1/n period to rectify a waveform of each phase of AC power. A reactor may be connected to rectify a waveform of each phase of AC power. The installation number of the converters 351 or the installation number of the inverters 52 is not limited to the installation number described above. When a rated current of the converter 351 or the inverter 52 is low, a plurality of the converters 351 or a plurality of the inverters 52 may be appropriately connected together in parallel.

Therefore, in the third embodiment, it is possible to obtain a desired number of phases of AC power without restriction to the number of stages of the stators 30 of the generator 300. That is, in the first embodiment, it is necessary to set the number of stages of the stators 30 to two times the number of phases of an AC power outputted from the generator 50; however, in the third embodiment, there is no restriction to the number of stages of the stators 30 as in the first embodiment.

In the third embodiment, similar to the first embodiment, because it is possible to use the converters 351 or the inverters 52 with a low rated voltage compared to when a power output of the generator 300 is converted by one converter or one inverter, it is possible to reduce component costs. Moreover, because it is possible to divide and take out the entire output voltage of the rotating electrical machine without using a transformer, it is possible to decrease the number of components by virtue of the transformer being omitted.

### Fourth Embodiment

Subsequently, a fourth embodiment of the present invention will be described with reference to the drawings. The configuration of a generator is the only difference between a rotating electrical machine system of the fourth embodiment and that of the first embodiment. For this reason, a description will be provided with the same reference signs being assigned to the same elements as in the first embodiment, and duplicated descriptions will be omitted.

Unlike the generators of the first to third embodiments being axial-gap type generators, the generator of the fourth embodiment is a radial-gap type generator. In this generator, the same iron core is wound with a plurality of coils.

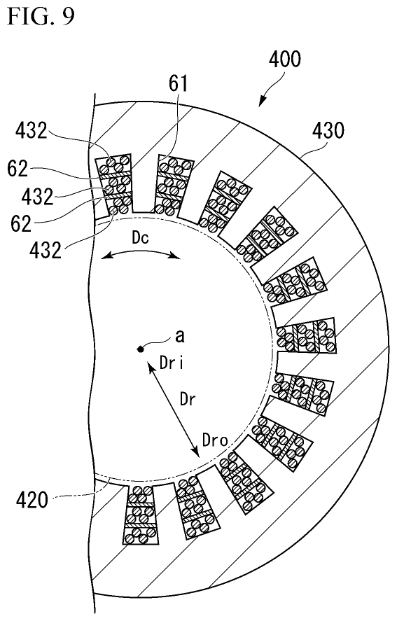

FIG. 9 is a view showing a schematic configuration of a stator of the generator according to the fourth embodiment of the present invention.

As shown in FIG. 9, a generator 400 of the fourth embodiment includes a rotary shaft (not shown); a rotor 420; a stator 430; and a casing (not shown).

The stator 430 includes an iron core 60 and a plurality of layers of coils 432. The iron core 60 has an annular shape that continues in the peripheral direction Dc. The iron core 60 has a plurality of slots 61 on the radial inside Dri, and the plurality of slots 61 are spaced apart from each other in the peripheral direction Dc.

The coil 432 is disposed in the slot 61 of the iron core 60. In the fourth embodiment, a plurality of (n number of) rooms are formed in one slot 61 by insulating panels 62. The plurality of rooms line up in the radial direction Dr. The plurality of rooms accommodate the plurality of coils 432 that form different Y connections. In other words, one slot 61 is layered inside, where the coils 432 forming different Y connections are laminated in the radial direction Dr. An insulating panel (not shown) is disposed also between the coil 432 and the iron core 60 so as for the coil 432 and the iron core 60 to be electrically insulated from each other. An insulating panel (not shown) between the insulating panel 62 and the coil 432, and the iron core 60 may have insulation properties responding to an inter-phase voltage or a phase voltage (iron core =ground potential). The insulating panel can be made of a planar material such as synthetic resin (for example, phenol resin), or mica tape. In FIG. 9, three layers of different coils 432 are provided in one slot 61; however, the number of layers of the coils 432 formed in one slot 61 is not limited to three. Two layers, or four or more layers may be formed.

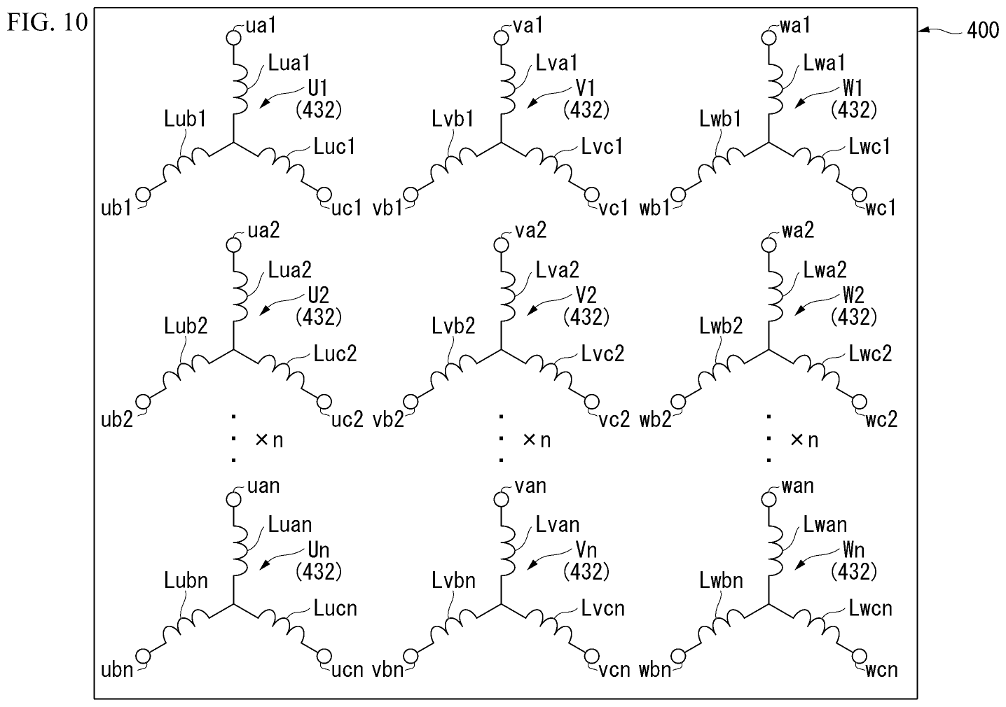

FIG. 10 is a diagram showing an equivalent circuit of a coil according to the fourth embodiment of the present invention. As shown in FIG. 10, the generator 400 of the fourth embodiment includes three-phase coils U1, U2, . . . Un (n is a natural number greater than or equal to three), three-phase coils V1, V2, . . . Vn (n is a natural number greater than or equal to three), and three-phase coils W1, W2, . . . Wn (n is a natural number greater than or equal to three), of which each three-phase coil has three coils that are connected together via Y connection.

The three-phase coil U1 includes three coils Lua1, Lub1, and Luc1, and terminals ua1, ub1, and uc1. The three-phase coil U2 includes three coils Lua2, Lub2, and Luc2, and terminals ua2, ub2, and uc2. The three-phase coil Un includes three coils Luan, Lubn, and Lucn, and terminals uan, ubn, and ucn (n is a natural number greater than or equal to three). When the rotor 420 having a permanent magnet rotates around the axis a, the three-phase coils U1, U2, . . . Un (n is a natural number greater than or equal to three) generate a U-phase AC power of a three-phase (U-phase, V-phase, and W-phase) AC power outputted from the power converter 450 (to be described later).

The three-phase coil V1 includes three coils Lva1, Lvb1, and Lvc1, and terminals va1, vb1, and vc1. The three-phase coil V2 includes three coils Lva2, Lvb2, and Lvc2, and terminals va2, vb2, and vc2. The three-phase coil Vn includes three coils Lvan, Lvbn, and Lvcn, and terminals van, vbn, and vcn (n is a natural number greater than or equal to three). When the rotor 420 having a permanent magnet rotates around the axis a, the three-phase coils V1, V2, . . . Vn (n is a natural number greater than or equal to three) generate a V-phase AC power of a three-phase (U-phase, V-phase, and W-phase) AC power outputted from the power converter 450 (to be described later).

The three-phase coil W1 includes three coils Lwa1, Lwb1, and Lwc1, and terminals wa1, wb1, and wc1. The three-phase coil W2 includes three coils Lwa2, Lwb2, and Lwc2, and terminals wa2, wb2, and wc2. The three-phase coil Wn includes three coils Lwan, Lwbn, and Lwcn, and terminals wan, wbn, and wcn (n is a natural number greater than or equal to three). When the rotor 420 having a permanent magnet rotates around the axis, the three-phase coils W1, W2, . . . Wn (n is a natural number greater than or equal to three) generate a W-phase AC power of a three-phase (U-phase, V-phase, and W-phase) AC power outputted from the power converter 450 (to be described later).

In the fourth embodiment, the coils Lua1, Lua2, . . . and Luan of the three-phase coils U1, U2, . . . Un are accommodated in the same slot 61 of the iron core 60. Similarly, the coils Lub1, Lub2, . . . and Lubn are also accommodated in the same slot 61. The coils Luc1, Luc2, . . . and Lucn are also accommodated in the same slot 61.

The coils Lva1, Lva2, . . . and Lvan of the three-phase coils V1, V2, . . . Vn are accommodated in the same slot 61 of the iron core 60. Similarly, the coils Lvb1, Lvb2, . . . and Lvbn are also accommodated in the same slot 61. The coils Lvc1, Lvc2, . . . and Lvcn are also accommodated in the same slot 61.

The coils Lwa1, Lwa2, . . . and Lwan of the three-phase coils W1, W2, . . . Wn are accommodated in the same slot 61 of the iron core 60. Similarly, the coils Lwb1, Lwb2, . . . and Lwbn are also accommodated in the same slot 61. The coils Lwc1, Lwc2, . . . and Lwcn are also accommodated in the same slot 61. The slot 61 accommodating the three-phase coils U1, U2, . . . Un, the slot 61 accommodating the three-phase coils V1, V2, . . . Vn, and the slot 61 accommodating the three-phase coils W1, W2, . . . Wn differ from each other.

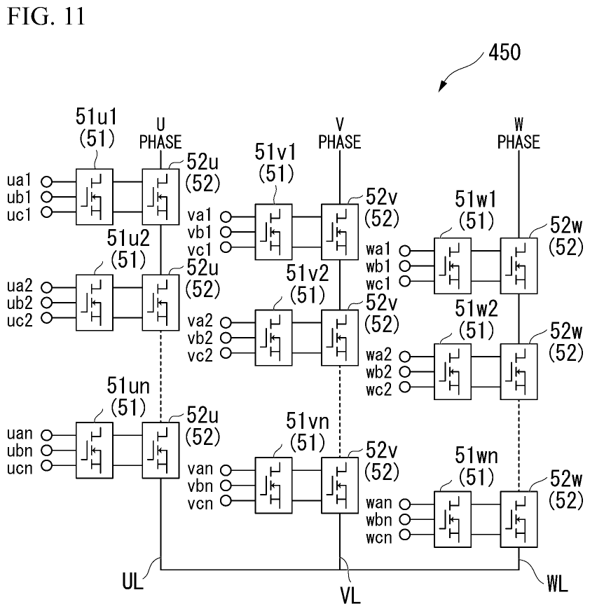

FIG. 11 is a diagram showing a schematic configuration of the power converter according to the fourth embodiment of the present invention. As shown in FIG. 11, the power converter 450 includes a plurality of the converters 51 and a plurality of the inverters 52. The power converter converts power generated by the generator. Similar to the first embodiment, the power converter of the embodiment outputs an AC power, which is generated by the generator 300, in the form of a three-phase (U-phase, V-phase, and W-phase) AC power at a commercial frequency (for example, 50 Hz or 60 Hz in Japan).

Each of the plurality of converters 51 converts a three-phase AC power into a DC power. In the fourth embodiment, the plurality of converters 51 include U-phase converters 51u1, 51u2, . . . and 51un (n is a natural number greater than or equal to three); V-phase converters 51v1, 51v2, . . . and 51vn (n is a natural number greater than or equal to three); and W-phase converters 51w1, 51w2, . . . and 51wn (n is a natural number greater than or equal to three). Similar to the first embodiment, a rectifier circuit in which diodes are used, or a bridge circuit built from switching elements can be used as each of the plurality of converters 51.

In the fourth embodiment, the terminals ua1, ub1, and uc1 are connected with the U-phase converter 51u1. The terminals ua2, ub2, and uc2 are connected with the U-phase converter 51u2. The terminals uan, ubn, and ucn are connected with the U-phase converter 51un. The terminals va1, vb1, and vc1 are connected with the V-phase converter 51v1. The terminals va2, vb2, and vc2 are connected with the V-phase converter 51v2. The terminals van, vbn, and vcn are connected with the V-phase converter 51vn. The terminals wa1, wb1, and wc1 are connected with the W-phase converter 51w1. The terminals wa2, wb2, and wc2 are connected with the W-phase converter 51w2. The terminals wan, wbn, and wcn are connected with the W-phase converter 51wn.

The inverters 52 are each connected to one of the plurality of converters 51. In other words, one inverter 52 is connected with one converter 51. The inverter 52 converts a DC power of the converter 51 into an AC power. Similar to the first embodiment, among the plurality of inverters 52, output terminals of a plurality of the inverters 52 outputting the same phase of AC power are connected together in series.

More specifically, output terminals of a plurality of the inverters 52u outputting a U-phase AC power are connected together in series, output terminals of a plurality of the inverters 52v outputting a V-phase AC power are connected together in series, and output terminals of a plurality of the inverters 52w outputting a W-phase AC power are connected together in series. That is, in the power converter 450 of the fourth embodiment, n (n is a natural number greater than or equal to three) number of the inverters 52 outputting each phase of AC power are connected together in series. In the fourth embodiment, the number of the inverters 52u outputting a U-phase AC power, the number of the inverters 52v outputting a V-phase AC power, and the number of the inverters 52w outputting a W-phase AC power are the same. In the fourth embodiment, the U-phase power line UL, the V-phase power line VL, and the W-phase power line WL, through which the inverters 52 are connected together in series, are connected together via Y connection in which the U-phase power line UL, the V-phase power line VL, and the W-phase power line WL are connected together via a neutral point. However, other connection methods may be adopted.

The inverters 52 outputting each phase of AC power is PWM controlled by a controller which is not shown. If n (n is a natural number greater than or equal to three) number of the inverters 52 outputting each phase of AC power are connected together in series, PWM control periods of the inverters 52 may be shifted from each other by a 1/n period to rectify a waveform of each phase of AC power. A reactor may be connected to rectify a waveform of each phase of AC power. The installation number of the converters 51 or the installation number of the inverters 52 is not limited to the installation number described above. When a rated current of the converter 51 or the inverter 52 is low, a plurality of the converters 51 or a plurality of the inverters 52 may be appropriately connected together in parallel.

In the fourth embodiment, a power output of the generator 400 of a radial-gap type, in which a plurality of layers of three-phase coils 432 are provided, is converted by the plurality of converters 51 and the plurality of inverters 52. For this reason, it is possible to obtain an AC power at a desired frequency via the inverters 52 regardless of a rotational speed of the generator 400. Moreover, because it is possible to divide and take out the entire output voltage of the generator 400 without using a transformer, it is possible to decrease the number of components by virtue of the transformer being omitted.

In the fourth embodiment, output terminals of n number of the inverters 52 outputting the same phase of AC power are connected together in series. For this reason, it is possible to easily increase the voltage of an AC power by increasing the number of the inverters 52 being connected together in series. Because it is possible to use the converters 51 or the inverters 52 with a low rated voltage compared to when a power output of the generator 400 is converted by one converter or one inverter, it is possible to reduce component costs.

### Fifth Embodiment

Subsequently, a fifth embodiment of the present invention will be described with reference to the drawings. The configuration of a generator is the only difference between a rotating electrical machine system of the fifth embodiment and that of the third embodiment. The only differences from the fourth embodiment are the configuration of a converter and the number of coils. For this reason, the same reference signs will be assigned to the same elements as in the third and fourth embodiments with reference to FIG. 9, and duplicated descriptions will be omitted.

Similar to the fourth embodiment, a generator of the fifth embodiment also is a radial-gap type generator. The generator includes a rotary shaft; the rotor 420; the stator 430; and a casing (none of those shown). Similar to the fourth embodiment, the stator 430 includes the iron core 60 and a plurality of layers of the coils 432. The iron core 60 has an annular shape that continues in the peripheral direction Dc. The iron core 60 has a plurality of the slots 61 on the radial inside Dri, and the plurality of slots 61 are spaced apart from each other in the peripheral direction Dc.

The coil 432 is disposed in the slot 61 of the iron core 60. A plurality of (n number of) rooms are formed in one slot by the insulating panels 62. The plurality of rooms line up in the radial direction Dr. The plurality of rooms accommodate the coils 432. In other words, one slot is layered inside, where different coils 432 are laminated in the radial direction Dr. An insulating panel (not shown) is disposed also between the coil 432 and the iron core 60 so as for the coil 432 and the iron core 60 to be electrically insulated from each other.

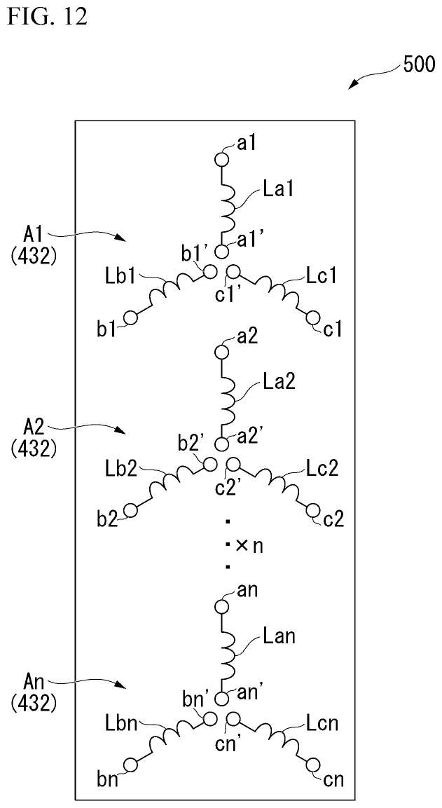

FIG. 12 is a diagram showing an equivalent circuit of a coil according to the fifth embodiment of the present invention.

As shown in FIG. 12, a generator 500 of the fifth embodiment includes three-phase coils A1, A2, . . . and An (n is a natural number greater than or equal to three), each of which has three divided coils. The three-phase coil A1 includes divided coils La1, Lb1, and Lc1, and the three-phase coil A2 includes divided coils La2, Lb2, and Lc2. The three-phase coil An includes divided coils Lan, Lbn, and Lcn (n is a natural number greater than or equal to three).

When the rotor 420 having a permanent magnet rotates around the axis a, the divided coils La1, La2, . . . Lan generate a U-phase AC power of a three-phase (U-phase, V-phase, and W-phase) AC power outputted from a power converter 550. When the rotor 420 rotates around the axis a, the divided coils Lb1, Lb2, . . . Lbn generate a V-phase AC power of a three-phase (U-phase, V-phase, and W-phase) AC power outputted from the power converter 550. When the rotor 420 rotates around the axis, the divided coils Lc1, Lc2, . . . Lcn generate a W-phase AC power of a three-phase (U-phase, V-phase, and W-phase) AC power outputted from the power converter 550 which will be described later.

In the fifth embodiment, the divided coils La1, La2, . . . and Lan (n is a natural number greater than or equal to three) are accommodated in the same slot 61 of the iron core 60. Similarly, the divided coils Lb1, Lb2, . . . and Lbn (n is a natural number greater than or equal to three) are also accommodated in the same slot 61. The divided coils Lc1, Lc2, . . . and Lcn (n is a natural number greater than or equal to three) are also accommodated in the same slot 61.

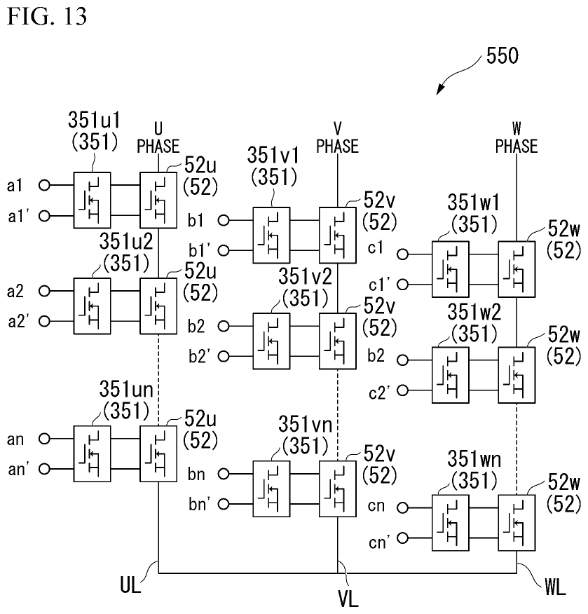

FIG. 13 is a diagram of the power converter according to the fifth embodiment of the present invention, which is equivalent to FIG. 11. As shown in FIG. 13, the power converter 550 includes a plurality of the converters 351 and a plurality of the inverters 52. The power converter 550 converts power generated by the generator 500. Similar to the first embodiment, the power converter 550 of the embodiment outputs an AC power, which is generated by the generator 500, in the form of a three-phase (U-phase, V-phase, and W-phase) AC power at a commercial frequency (for example, 50 Hz or 60 Hz in Japan).

Each of the plurality of converters 351 converts a single-phase AC power into a DC power. In the fifth embodiment, the plurality of converters 351 include U-phase converters 351u1, 351u2, . . . and 351un (n is a natural number greater than or equal to three); V-phase converters 351v1, 351v2, . . . and 351vn (n is a natural number greater than or equal to three); and W-phase converters 351w1, 351w2, . . . and 351wn (n is a natural number greater than or equal to three). Similar to the first embodiment, a rectifier circuit in which diodes are used, or a bridge circuit built from switching elements can be used as each of the plurality of converters 351.

Terminals a1 and a1′ of the coil La1 are connected with the U-phase converter 351u1. Terminals a2 and a2′ of the coil La2 are connected with the U-phase converter 351u2. Terminals an and an′ of the coil Lan are connected with the U-phase converter 351un. Hereinbelow, similarly, terminals b1 and b1′ of the coil Lb1 are connected with the V-phase converter 351v1. Terminals b2 and b2′ of the coil Lb2 are connected with the V-phase converter 351v2. Terminals bn and bn′ of the coil Lbn are connected with the V-phase converter 351vn. Terminals c1 and c1′ of the coil Lc1 are connected with the W-phase converter 351w1. Terminals c2 and c2′ of the coil Lc2 are connected with the W-phase converter 351w2. Terminals cn and cn′ of the coil Lcn are connected with the W-phase converter 351wn.

The inverters 52 are each connected to one of the plurality of converters 351. That is, similar to the fourth embodiment, one inverter 52 is connected with one converter 351. The inverter 52 converts a DC power of the converter 351 into an AC power. Similar to the first embodiment, among the plurality of inverters 52, output terminals of a plurality of the inverters 52 outputting the same phase of AC power are connected together in series.

More specifically, output terminals of a plurality of the inverters 52u outputting a U-phase AC power are connected together in series, output terminals of a plurality of the inverters 52v outputting a V-phase AC power are connected together in series, and output terminals of a plurality of the inverters 52w outputting a W-phase AC power are connected together in series. That is, similar to the fourth embodiment, in the power converter 550 of the fifth embodiment, n (n is a natural number greater than or equal to three) number of the inverters 52 outputting each phase of AC power are connected together in series. The number of the inverters 52u outputting a U-phase AC power, the number of the inverters 52v outputting a V-phase AC power, and the number of the inverters 52w outputting a W-phase AC power are the same. In the fifth embodiment, the U-phase power line UL, the V-phase power line VL, and the W-phase power line WL, through which the inverters 52 are connected together in series, are connected together via Y connection in which the U-phase power line UL, the V-phase power line VL, and the W-phase power line WL are connected together via a neutral point. However, other connection methods may be adopted.

The inverters 52 outputting each phase of AC power is PWM controlled by a controller which is not shown. Similar to the fourth embodiment, also in the fifth embodiment, if n (n is a natural number greater than or equal to three) number of the inverters 52 outputting each phase of AC power are connected together in series, PWM control periods of the inverters 52 may be shifted from each other by a 1/n period to rectify a waveform of each phase of AC power. A reactor may be connected to rectify a waveform of each phase of AC power. The installation number of the converters 351 or the installation number of the inverters 52 is not limited to the installation number described above. When a rated current of the converter 351 or the inverter 52 is low, a plurality of the converters 351 or a plurality of the inverters 52 may be appropriately connected together in parallel.

Similar to the fourth embodiment, the generator 500 of the fifth embodiment is a radial-gap type generator, and is provided with a plurality of layers of the three-phase coils 432 are provided. A power output of the generator 500 of the fifth embodiment is converted by the plurality of converters 351 and the plurality of inverters 52. For this reason, similar to the fourth embodiment, it is possible to obtain power at a desired frequency via the inverters 52 regardless of a rotational speed of the generator 500. Moreover, because it is possible to divide and take out the entire output voltage of the generator 500 without using a transformer, it is possible to decrease the number of components by virtue of the transformer being omitted.

In the fifth embodiment, output terminals of n number of the inverters 52 outputting the same phase of AC power are connected together in series. For this reason, it is possible to easily increase the voltage of an AC power by increasing the number of the inverters 52 being connected together in series. Because it is possible to use the converters 351 or the inverters 52 with a low rated voltage compared to when a power output of the generator 500 is converted by one converter or one inverter, it is possible to reduce component costs.

In the fifth embodiment, single-phase powers of the three-phase coils A1, A2, . . . and An are converted into DC powers by the converter 351. For this reason, similar to the fourth embodiment, compared to when a three-phase AC power is converted into a DC power by the converter 51, the fifth embodiment has the advantage that there is no restriction to the number of phases such as the number of layers of the coils of the generator 500 being a multiple of 3.

### Sixth Embodiment

Subsequently, a sixth embodiment of the present invention will be described with reference to the drawings. A rotating electrical machine of the sixth embodiment differs in the structure of a coil from the rotating electrical machine of the first embodiment. For this reason, a description will be provided with the same reference signs being assigned to the same elements as in the first embodiment, and duplicated descriptions will be omitted.

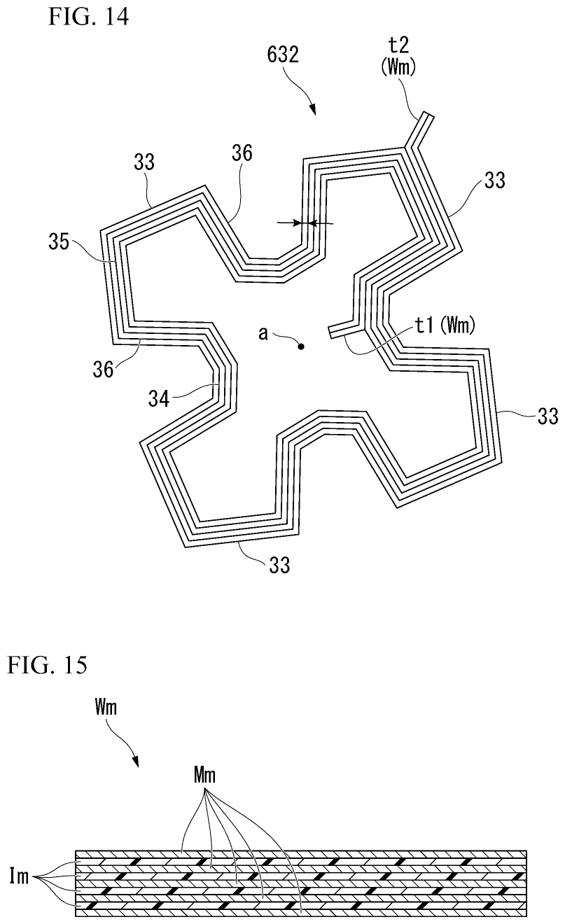

FIG. 14 is a view of the sixth embodiment of the present invention, which is equivalent to FIG. 3. FIG. 15 is a magnified view of a wire rod according to the sixth embodiment of the present invention.

Similar to the generator 100 of the first embodiment, a generator (not shown) of the sixth embodiment also is an axial-gap type AC generator. The generator includes the rotary shaft 10; the rotor 20; a stator 630; and the casing 40. One stator 630 includes three-phase coils 632 and a mold portion 31.

As shown in FIG. 14, the coil 632 of one phase includes four winding portions 33 that protrude to the radial outside Dro relative to the axis a serving as a center. Four winding portions 33 are provided every 90 degrees in a peripheral direction Dc around the axis a. Similar to the coil 32 of the first embodiment, the coil 632 includes the inner coil end portion 34; the outer coil end portion 35; and the coil slot portion 36. Similar to the first embodiment, the inner coil end portion 34 may have the inner notch portions 37A and 37B (refer to FIG. 4). The outer coil end portion 35 may have the outer notch portions 38A and 38B (refer to FIG. 4).

The coil 632 has two end portions t1 and t2. The coil 632 has the end portion t1 on the radial inside Dri. The coil 632 has the end portion t2 on the radial outside Dro. The end portions t1 and t2 are connected to lead wires (not shown). Similar to the first embodiment, a method of winding the coil 632 of the stator 630 of the sixth embodiment is a coreless method, and winding is distributed over a plurality of slots, and is wave winding. The position of the end portion t1 is not limited to a region in the inner coil end portion 34, and the position of the end portion t2 is not limited to a region in the outer coil end portion 35.

The coil 632 includes a wire rod Wm. The wire rod Wm is wound multiple times in the peripheral direction Dc around the axis a. In other words, in the coil 632, while forming four winding portions 33, one piece of the wire rod Win is laminated in a direction (in other words, direction in which fluxes link with the coil) intersecting the axis a. Because a potential occurs between windings of the wire rod Wm which are adjacent to each other in the radial direction Dr, if the potential is high, insulating sheet or glass fiber reinforced plastic (GFRP) prepreg having a high fiber content may be interposed between the windings of the wire rod Wm so as for the windings of the wire rod Wm to be electrically insulated from each other.

As shown in FIG. 15, the wire rod Wm includes a plurality of magnetic material layers Mm and a plurality of insulating material layers Im. The plurality of magnetic material layers Mm are independent of each other. The plurality of magnetic material layers Mm are superimposed on each other with the insulating material layer Im interposed therebetween. The magnetic material layer Mm can be made of copper. The magnetic material layer Mm of the embodiment is made of a rectangular copper wire. A rectangular thin wire having an aspect ratio (ratio of thickness to width) greater than 20 may be used as the rectangular wire of which the magnetic material layer Mm is made. The aspect ratio of the rectangular wire may be 40±10. The thickness of the rectangular wire may be less than a skin depth for the frequency of current flowing through the coil 632. An insulating layer made of polyimide may be formed on the surface of the wire rod Wm via electroplating.

The plurality of magnetic material layers Mm are electrically insulated from each other via the insulating material layers Im. An organic material (for example, plastic) or a composite material (for example, GFRP prepreg) which has good electrical insulation properties can be used as a material of the insulating material layer Im. The insulating material layer Tin fixes adjacent magnetic material layers Mm in a state where a plurality of the winding portions 33 are formed by winding the wire rod Wm. When the insulating material layer Im is made of a composite material, it is possible to fix adjacent magnetic material layers Mm by forming and then sintering the plurality of winding portions 33. Because adjacent magnetic material layers Mm are fixed with the insulating material layer Im, it is possible to prevent vibration, and prevent wear or damage to the coil 632.

Therefore, in the sixth embodiment, because adjacent magnetic material layers Mm are electrically insulated from each other by virtue of the insulating material layer Im, it is possible to decrease an eddy current loss in the entirety of the coil 632, and prevent heat generation or a decrease in efficiency. Because it is possible to prevent an increase in current density, it is possible to further prevent heat generation caused by Joule heat.

### Seventh Embodiment

Subsequently, a seventh embodiment of the present invention will be described with reference to the drawings. A rotating electrical machine of the seventh embodiment differs in the structure of a casing from the rotating electrical machines of the first and sixth embodiments. For this reason, a description will be provided with the same reference signs being assigned to the same elements as in the first and sixth embodiments, and duplicated descriptions will be omitted.

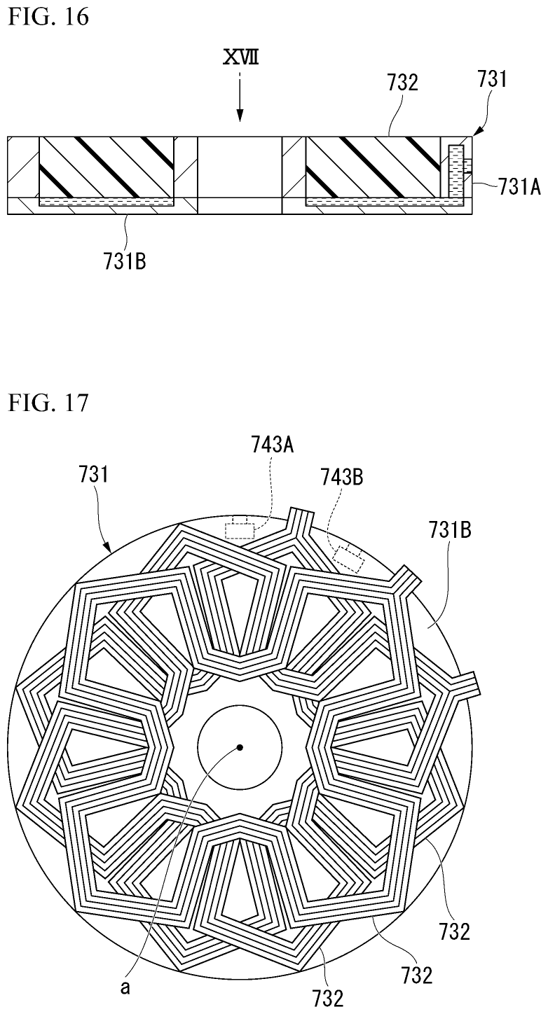

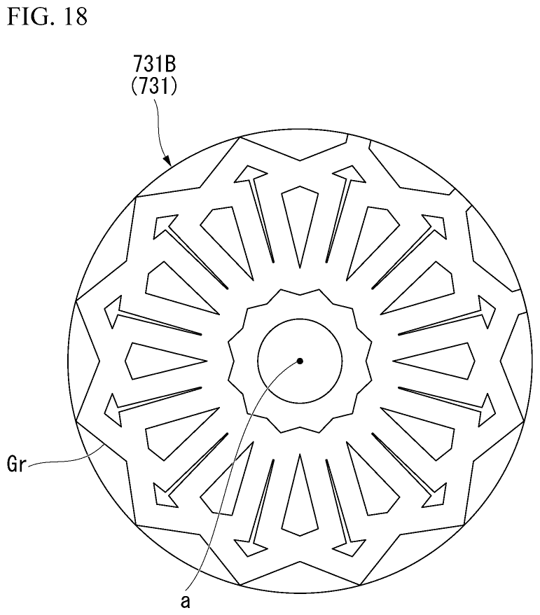

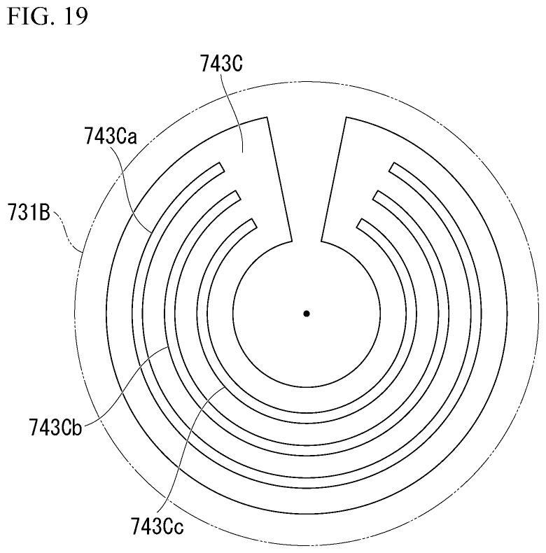

FIG. 16 is a cross-sectional view of a stator according to the seventh embodiment of the present invention. FIG. 17 is a view as seen in a direction XVII of FIG. 16. FIG. 18 is a view of a stator unit as seen in the direction XVII of FIG. 16. FIG. 19 is a cross-sectional view of an axial mold portion according to the seventh embodiment of the present invention.

Similar to the generator 100 of the first embodiment, a generator (not shown) of the seventh embodiment also is an axial-gap type AC generator. The generator includes the rotary shaft 10 (not shown); the rotor 20 (not shown); a stator 730; and the casing 40 (not shown). One stator 730 includes three-phase coils 732 and a mold portion 731. The coil 32 of the first embodiment or the coil 632 of the sixth embodiment can be used as the coil 732.

As shown in FIGS. 16 and 17, the mold portion 731 includes a mold body portion 731A and an axial mold portion 731B. The mold body portion 731A covers the coil 732 from an outside of the radial outside Dro. The mold body portion 731A is supported by the casing 40 (not shown). A composite material (for example, fiber-reinforced composite material) or ceramic can be used as a material of the mold portion 731. Two refrigerant flow paths 743A and 743B extending in the axial direction Da are formed inside the mold body portion 731A of the embodiment. A refrigerant flows into one of the refrigerant flow paths 743A and 743B from the outside, and flows from the other to the outside. Pitch-based carbon fibers, polyacrylonitrile (PAN)-based carbon fibers, or mica particles can be used as an additive (in other words, filler) of the mold portion 731. The use of pitch-based carbon fibers is advantageous in improving heat conductivity. The use of polyacrylonitrile (PAN)-based carbon fibers is advantageous in improving a strength. The use of mica particles is advantageous in improving insulation properties.

The axial mold portion 731B covers the coil 32 in the axial direction Da. The axial mold portion 731B of the embodiment has a circular disc as seen in the axial direction Da.

As shown in FIGS. 17 to 19, the axial mold portion 731B includes a groove Gr and a peripheral refrigerant flow path 743C.

The groove Gr accommodates a plurality of the coils 32 in the axial direction Da. As shown in FIG. 18, the groove Gr of the embodiment is recessed in the axial direction Da to correspond to a shape in which three coils 32 overlap each other in the axial direction Da.

The refrigerant flows through the peripheral refrigerant flow path 743C in the peripheral direction Dc. As shown in FIG. 19, the peripheral refrigerant flow path 743C of the embodiment has a C shape as seen in the axial direction Da. One end of the peripheral refrigerant flow path 743C having a C shape in the peripheral direction is connected with one of the refrigerant flow paths 743A and 743B, and the other end of the peripheral refrigerant flow path 743C in the peripheral direction is connected with the other of the refrigerant flow paths 743A and 743B. That is, the refrigerant flows between one end and the other end of the peripheral refrigerant flow path 743C in the peripheral direction Dc. In the embodiment, the size of the peripheral refrigerant flow path 743C in the radial direction Dr is slightly smaller than the size of the axial mold portion 731B in the radial direction Dr.

The peripheral refrigerant flow path 743C of the embodiment is provided with a plurality of C-shaped wall portions 743Ca to 743Cc that divide the inside of the peripheral refrigerant flow path 743C in the radial direction. It is possible to prevent a bias, more specifically, a bias in the radial direction Dr in flow rate of the refrigerant flowing through the inside of the peripheral refrigerant flow path 743C by providing the wall portions 743Ca to 743Cc. Insulating oil as the refrigerant may be allowed to flow. If such insulating oil is allowed to flow, it is possible to improve insulation properties. In the example, the peripheral refrigerant flow path 743C includes three wall portions 743Ca to 743Cc. On the other hand, the wall portions 743Ca to 743Cc may be omitted. The peripheral refrigerant flow path 743C may be provided with four or more C-shaped wall portions.

Therefore, in the seventh embodiment, because the mold portion 731 is made of a composite material, it is possible to easily adjust heat conduction, insulation properties, and heat resistance.

Because the refrigerant or insulating oil is allowed to flow through the refrigerant flow paths 743A and 743B and the peripheral refrigerant flow path 743C of the mold portion 731, it is possible to improve cooling and insulation properties.

Because the axial mold portion 731B has the groove Gr, it is possible to more firmly fix the mold portion 731 to the coil 732. It is possible to increase a contact area between the axial mold portion 731B and the coil 732. For this reason, it is possible to efficiently cool the coil 732 without increasing a flow rate of the refrigerant.

### Eighth Embodiment

Subsequently, an eighth embodiment of the present invention will be described with reference to the drawings.

Similar to the first embodiment, a rotating electrical machine system of the eighth embodiment of the present invention includes .a rotating electrical machine and a power converter. The rotating electrical machine of the eighth embodiment is an axial-gap type generator. The generator of the eighth embodiment is an AC generator used in wind power generation, hydroelectric power generation, or the like. The rotating electrical machine may be a motor generator.

Typically, it is possible to achieve a size reduction, a weight reduction, and high efficiency for high-speed rotation of a rotating electrical machine. In the rotating electrical machine, when a rotor rotates at a high speed, a large centrifugal force becomes applied to a magnet of the rotor. For this reason, there is the possibility that an air gap occurs between the magnet and the rotor due to the magnet being deformed, and torque transmission from the magnet to a rotor shaft is hindered. In the rotating electrical machine system of the eighth embodiment, it is possible to prevent a decrease in torque transmission between the magnet and the rotor shaft. The entire configuration of the rotating electrical machine system will be described hereinbelow with reference to FIG. 1. The same reference signs will be assigned to the same elements as in the first embodiment, and duplicated descriptions will be omitted.

As shown in FIG. 1, the generator 100, which is the rotating electrical machine of the embodiment, includes the rotary shaft 10; a rotor 820; the stator 30; and the casing 40. The rotary shaft 10 can rotate around the axis a while being supported by the casing 40. Rotational energy is input to the rotary shaft 10 from a drive source such as a turbine or windmill.

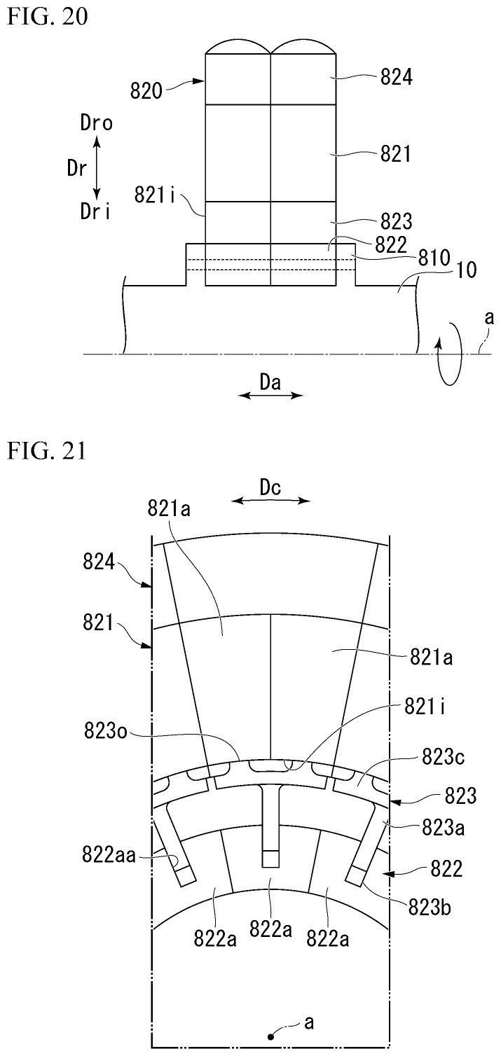

The rotor 820 extends from the outer peripheral surface 10a of the rotary shaft 10 to the radial outside Dro. That is, the rotor 820 can rotate with the rotary shaft 10 around the axis a. The rotor 820 has a circular disc shape having the axis a as a center, and has a permanent magnet 821 (refer to FIG. 20) in a center portion (center portion in the radial direction Dr) of the rotor 20. In the generator 100 of the embodiment, a plurality of stages of the rotors 820 are provided to be spaced apart from each other in the axial direction Da.

The stator 30 is disposed to face the rotor 820, and be spaced by a small clearance from the rotor 820 in the axial direction Da. The stator 30 has the coil 32 generating a rotating field for rotating the rotor 820. The casing 40 covers the stator 30 and the rotor 820 from the radial outside Dro. The bearings 41 are provided at both end portions of the casing 40 in the axial direction Da, and rotatably support the rotary shaft 10.

FIG. 20 is a cross-sectional view of the rotor according to the eighth embodiment of the present invention. FIG. 21 is a view of the rotor as viewed in the axial direction according to the eighth embodiment of the present invention.

As shown in FIGS. 20 and 21, the rotor 820 includes an inner ring portion 822; a torque transmission portion 823; the permanent magnet 821; and an outer ring portion 824.

The inner ring portion 822 is fixed to the rotary shaft 10. In the inner ring portion 822, a plurality of fan-shaped first blocks 822a are disposed to line up in the peripheral direction Dc. The first blocks 822a are tightened to a protrusion portion 810, which is formed on the outer peripheral surface of the rotary shaft 10, via fasteners such as bolts. The inner ring portion 822 of the embodiment can be made of synthetic resin such as phenol resin. The inner ring portion 822 may be made of a composite material such as carbon fiber reinforced plastic. A keyway 822aa is formed in an outer peripheral surface (facing the radial outside Dro) of each of the first blocks 822a, and is recessed to the radial inside Dri.

The torque transmission portion 823 presses the permanent magnet 821 to the radial outside Dro, and transmits a rotational torque around the axis a, which is applied to the permanent magnet 821, to the rotary shaft 10. In other words, even though the permanent magnet 821 is displaced or deformed due to centrifugal force at the rotation of the rotor 820, the torque transmission portion 823 efficiently transmits a rotational torque of the permanent magnet 821 to the rotary shaft 10. The torque transmission portion 823 of the eight embodiment has a key portion 823a; a spring portion 823b; and a surface contact portion 823c.

An end portion of the key portion 823a is disposed in the keyway 822aa, and can slide in the radial direction Dr. In other words, the key portion 823a can come in and out of the keyway 822aa in the radial direction Dr.

The spring portion 823b biases the key portion 823a to the radial outside Dro. The spring portion 823b can be disposed such that the spring portion 823b is compressed between an end portion of the key portion 823a on the radial inside Dri and a bottom portion of the keyway 822aa. A coil spring can be used as the spring portion 823b. If the spring portion 823b is a spring capable of biasing the key portion 823a to the radial outside Dro, other elastic members such as plate spring may be used as the spring portion 823b.

The surface contact portion 823c has an outer surface 823o that is parallel to an inner peripheral surface 821i (positioned on the radial inside Dri of the permanent magnet 821 disposed in a ring shape. Because the surface contact portion 823c is pressed from the radial inside Dri by the key portion 823a, the surface contact portion 823c is biased to the radial outside Dro. Therefore, the entirety of the outer surface 823o is in surface contact with the inner peripheral surface 821i. In the embodiment, the inner peripheral surface 821i of the permanent magnet 821 has a round tubular shape having the axis a as a center. The outer surface 823o of the surface contact portion 823c has the same radius of curvature as that of the inner peripheral surface 821i as seen in the axial direction Da.

The permanent magnet 821 has a ring shape having the axis a as a center. The permanent magnet 821 includes a plurality of fan-shaped magnet blocks 821a that are disposed to line up in the peripheral direction Dc.

The outer ring portion 824 serves as a reinforcement member against centrifugal force applied at the rotation of the rotor 820. In other words, the outer ring portion 824 prevents a displacement of the permanent magnet 821 to the radial outside Dro, which is caused by centrifugal force. The outer ring portion 824 of the embodiment has a ring shape that covers the permanent magnet 821 from the radial outside Dro. The outer ring portion 824 can be made of a composite material such as carbon fiber reinforced plastic.

Therefore, in the eight embodiment, because the surface contact portion 823c is biased to the radial outside Dro, even though centrifugal force is applied to the permanent magnet 821, the entirety of the outer surface of the surface contact portion 823c can remain in surface contact with the inner peripheral surface 821i of the permanent magnet 821. As a result, it is possible to prevent losses in torque transmission between the permanent magnet 821 and the rotary shaft 10. In the eighth embodiment, the rotor 820 includes the inner ring portion 822; however, the inner ring portion 822 may be omitted by forming the keyway 822aa of the inner ring portion 822 in the rotary shaft 10.

### Modification Example of Eighth Embodiment

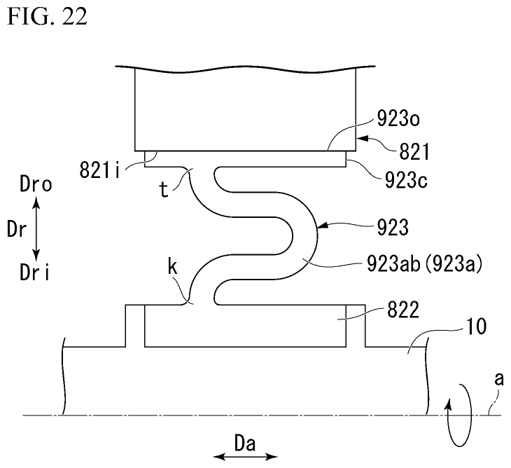

In the eighth embodiment, the torque transmission portion 823 includes the key portion 823a; the spring portion 823b; and the surface contact portion 823c. Regardless of whether the permanent magnet 821 is displaced or deformed due to centrifugal force, insofar as the torque transmission portion can transmit a rotational torque (applied to the permanent magnet 821) around the axis a to the rotary shaft 10, the configuration of the torque transmission portion is not limited to the configuration described above. The torque transmission portion may have a configuration shown in FIG. 22. In a modification example of the eighth embodiment, the same reference signs will be assigned to the same elements as in the eighth embodiment, and duplicated descriptions will be omitted.

FIG. 22 is a cross-sectional view of a torque transmission portion according to the modification example of the eighth embodiment of the present invention. As shown in FIG. 22, in the modification example of the eighth embodiment, a torque transmission portion 923 has an elastic bending portion 923a and a surface contact portion 923c. Similar to the torque transmission portion 823 of the eighth embodiment, even though the permanent magnet 821 is displaced or deformed due to centrifugal force at the rotation of a rotor, the torque transmission portion 923 can efficiently transmit a rotational torque of the permanent magnet 821 to the rotary shaft 10.

The elastic bending portion 923a is disposed between the inner ring portion 822 and the surface contact portion 923c. The elastic bending portion 923a biases the surface contact portion 923c to the radial outside Dro. The elastic bending portions 923a form a ring shape having the axis a as a center. A base portion k (positioned on the radial inside Dri) of the elastic bending portion 923a is fixed to the inner ring portion 822, and an end portion t (positioned on the radial outside Dro) of the elastic bending portion 923a is fixed to the surface contact portion 923c. The elastic bending portion 923a includes a U-shaped spring portion 923ab that is folded at least once in the axial direction Da. When the torque transmission portion 923 is mounted in a rotor 920, the spring portion 923ab is compressed and deformed in the radial direction Dr. The elastic bending portion 923a can be made of synthetic resin.

The surface contact portion 923c has an outer surface 923o that is parallel to the inner peripheral surface 821i (positioned on the radial inside Dri of the permanent magnet 821 disposed in a ring shape. The surface contact portion 923c is biased to the radial outside Dro by the elastic bending portion 923a. Therefore, the entirety of the outer surface 923o of the surface contact portion 923c is in surface contact with the inner peripheral surface 821i of the permanent magnet 821. In the embodiment, the outer surface 923o of the surface contact portion 923c has the same radius of curvature as that of the inner peripheral surface 821i of the permanent magnet 821 as seen in the axial direction Da.

Therefore, the modification example of the eighth embodiment has the following effect in addition to the operational effects of the eighth embodiment: even though an angle of the inner peripheral surface 821i of the permanent magnet 821 is changed due to centrifugal force, because the U-shaped spring portion is elastically deformed, the outer surface 923o of the surface contact portion 923c can travel in response to a change in the angle of the inner peripheral surface 821i. As a result, because the entirety of the outer surface 923o of the surface contact portion 923c is in surface contact with the inner peripheral surface 821i of the permanent magnet 821, it is possible to efficiently transmit a torque of the permanent magnet 821 to the inner ring portion 822.

The rotor 820 of the eighth embodiment and the rotor 920 of the modification example may be used in proper combination with elements of the first to seventh embodiments. The rotors 820 and 920 may be used in rotating electrical machines not shown in the first to seventh embodiments.

### Ninth Embodiment

Subsequently, a ninth embodiment of the present invention will be described with reference to the drawings.

Similar to the first embodiment, a rotating electrical machine system of the ninth embodiment of the present invention includes .a rotating electrical machine and a power converter. The rotating electrical machine of the ninth embodiment is an axial-gap type generator. The generator of the ninth embodiment is an AC generator used in wind power generation, hydroelectric power generation, or the like. The rotating electrical machine may be a motor generator.

Typically, as the number of divisions of a permanent magnet of a rotating electrical machine in one direction of the peripheral direction Dc and the radial direction Dr relative to the axis a serving as a center increases, an eddy current loss decreases. Upon the assumption that the numbers of divisions of the permanent magnet of the rotating electrical machine are the same, an eddy current loss further decreases when the permanent magnet is divided in one direction of the peripheral direction Dc and the radial direction Dr than when the permanent magnet is divided in both of the peripheral direction Dc and the radial direction Dr.

If the number of divisions in one direction of the peripheral direction Dc and the radial direction Dr increases, the thickness of a magnet block becomes thin, and a high machining accuracy becomes required. For this reason, a problem such as cost increase occurs. In a method of manufacturing a permanent magnet of the rotating electrical machine of the ninth embodiment, it is possible to optimize the number of divisions of the permanent magnet.

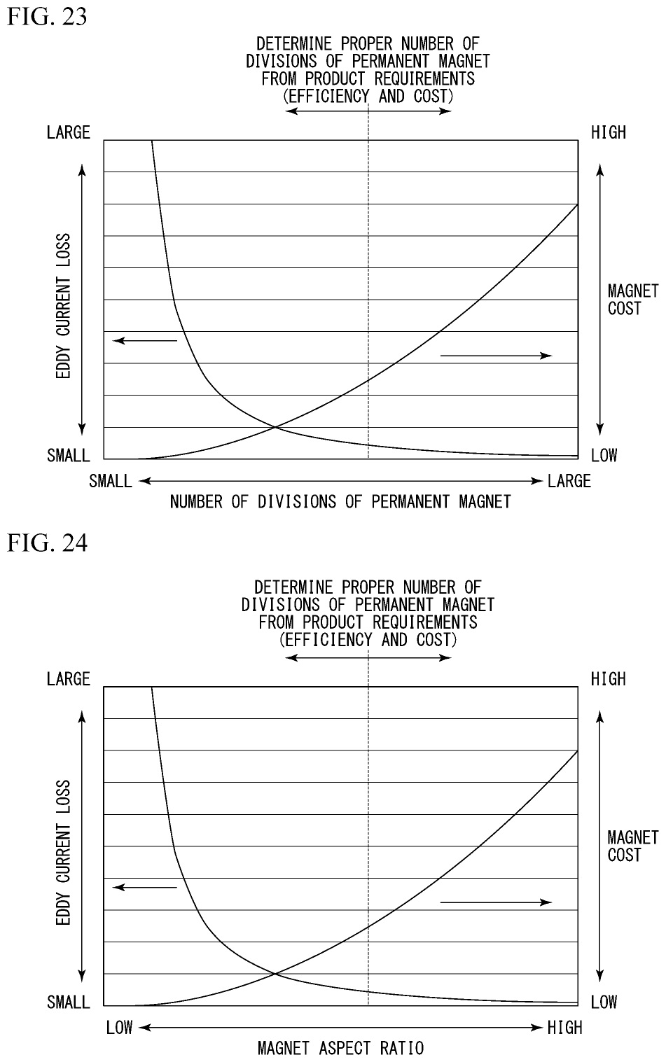

FIG. 23 is a graph with eddy current loss and magnet cost on the vertical axis, and the number of divisions of a magnet on the horizontal axis.

As shown in FIG. 23, as the number of divisions of the permanent magnet increases (from “small” to “large” in FIG. 23), the eddy current loss decreases. More specifically, the closer the number of divisions becomes to “0”, the greater a decreasing rate of the eddy current loss becomes, and as the number of divisions increases, the decreasing rate decreases. As the number of divisions of the permanent magnet increases, the magnet cost increases. More specifically, as the number of divisions of the permanent magnet increases, an increasing rate of the magnet cost slightly increases. The “magnet cost” refers to a cost taken to form magnet blocks of the permanent magnet.

In the ninth embodiment, upper limit values are set for each of the eddy current loss and the magnet cost satisfying product requirements (efficiency and cost) of the rotating electrical machine, and the number of divisions of the permanent magnet is determined within a range where the eddy current loss and the magnet cost do not exceed the upper limit values in FIG. 23.

Therefore, in the ninth embodiment, it is possible to optimize the number of divisions of the permanent magnet in one of the peripheral direction Dc and the radial direction Dr so as to satisfy the product requirements (efficiency and cost) of the rotating electrical machine.

### Modification Example of Ninth Embodiment

In the ninth embodiment, the permanent magnet is divided in one of the peripheral direction Dc and the radial direction Dr of the permanent magnet. The permanent magnet may be divided in both of the peripheral direction Dc and the radial direction Dr. In a modification example of the ninth embodiment, the shape (division shape: magnet aspect ratio) of each of magnet blocks of a permanent magnet is determined. The aspect ratio is a ratio of the size of a magnet block in the peripheral direction Dc to the size of the magnet block in the radial direction Dr. In the embodiment, the aspect ratio is (the length of a long side)/(the length of a short side) of a magnet block as seen in the axial direction Da.

FIG. 24 is a graph with eddy current loss and magnet cost on the vertical axis, and magnet aspect ratio on the horizontal axis.

As shown in FIG. 24, as the magnet aspect ratio of the permanent magnet increases, the eddy current loss decreases. More specifically, the less the magnet aspect ratio is, the greater a decreasing rate of the eddy current loss becomes, and as the magnet aspect ratio increases, the decreasing rate decreases. As the magnet aspect ratio of the permanent magnet increases, the magnet cost increases. More specifically, as the magnet aspect ratio of the permanent magnet increases, an increasing rate of the magnet cost slightly increases.

In the modification example of the ninth embodiment, upper limit values are set for each of the eddy current loss and the magnet cost satisfying product requirements (efficiency and cost) of the rotating electrical machine, and the magnet aspect ratio of the permanent magnet is determined within a range where the eddy current loss and the magnet cost do not exceed the upper limit values in FIG. 24.

Therefore, in the modification example of the ninth embodiment, when the permanent magnet is divided in both of the peripheral direction Dc and the radial direction Dr, it is possible to optimize the magnet aspect ratio of the magnet block of the permanent magnet so as to satisfy the product requirements (efficiency and cost) of the rotating electrical machine.

The permanent magnets manufactured according to the ninth embodiment and the modification example of the ninth embodiment may be used in proper combination with elements of the first to eighth embodiments. The permanent magnet may be used in rotating electrical machines not shown in the first to eighth embodiments.

### Other Modification Examples

The present invention is not limited to the embodiments, and various modifications can be made to the embodiments without departing from the spirit of the present inventions. That is, specific shapes or configurations shown in the embodiments are only examples, and can be appropriately modified.

In each of the power converters 50, 350, 450, and 550 of the embodiments, three or more inverters 52 for each of U, V, and W phases are connected together in series. The number of the inverters 52 being connected together in series is not limited to three or more, and two inverters 52 may be connected together in series.

The power converters 50, 350, 450, and 550 of the embodiments output a three-phase AC power; however, AC power is not limited to the three-phase AC power. A single-phase or two-phase AC power may be outputted. A single-phase or two-phase AC power of a plurality of systems may be outputted.

In the fourth embodiment, the plurality of (n number of) rooms are formed in one slot 61 by the insulating panels 62. A structure of separating or insulating the plurality of coils 432 from each other is not limited to the structure shown in the fourth embodiment. Any structure may be adopted insofar as the structure can separate or insulate the plurality of coils 432 from each other.

In the sixth embodiment, the generator is an axial-gap type AC generator. The generator is not limited to an axial-gap type generator, and a radial-gap type generator may be applied.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10: rotary shaft
20, 420, 820: rotor
30, 430, 630, 730: stator
31, 731: mold portion
32, 432, 632, 732: coil
33: winding portion
34: inner coil end portion
35: outer coil end portion
36: coil slot portion
37A, 37B: inner notch portion
38A, 38B: outer notch portion
39: planar lamination portion
40: casing
41: bearing
42: outer peripheral portion
43, 743A, 743B: refrigerant flow path
44: through hole
45: O-ring
50, 350, 450, 550: power converter
51, 351: converter
52: inverter
60: iron core
61: slot
62: insulating panel
100, 200, 300, 400, 500: generator
810: protrusion portion
821: permanent magnet
822: inner ring portion
822a: first block
822aa: keyway
823, 923: torque transmission portion
823a: key portion
823b: spring portion
823c, 923c: surface contact portion
823o, 923o: outer surface
824: outer ring portion
920: rotor
923a: elastic bending portion
923ab: spring portion

What is claimed is:

1. A coil, a plurality of which are disposed to overlap each other in an axial direction, and to have different phases around an axis, the coil comprising:
an inner coil end portion extending in a peripheral direction around the axis;
an outer coil end portion disposed closer to an outside than the inner coil end portion in a radial direction relative to the axis serving as a center, and extending in the peripheral direction; and
a coil slot portion extending in the radial direction, and electrically connecting an end portion of the inner coil end portion in the peripheral direction with an end portion of the outer coil end portion in the peripheral direction,
wherein the inner coil end portion includes an inner notch portion that is positioned to overlap an inner coil end portion of another coil which is adjacent to the coil in the axial direction as seen in the axial direction, and that is capable of accommodating the inner coil end portion of the other coil in the axial direction, and
wherein the outer coil end portion includes an outer notch portion that is positioned to overlap an outer coil end portion of the other coil which is adjacent to the coil in the axial direction as seen in the axial direction, and that is capable of accommodating the outer coil end portion of the other coil in the axial direction.

2. The coil according to claim 1,
wherein the inner coil end portion includes
a first inner notch portion that is provided to overlap an inner coil end portion of another first coil which is adjacent to the coil on one side in the axial direction, and is capable of accommodating the inner coil end portion of the first coil from one side in the axial direction, and
a second inner notch portion that is provided to overlap an inner coil end portion of another second coil which is adjacent to the coil on the other side in the axial direction, and is capable of accommodating the inner coil end portion of the second coil from the other side in the axial direction.

3. The coil according to claim 1,
wherein the outer coil end portion includes
a first outer notch portion that is provided to overlap an outer coil end portion of the other first coil which is adjacent to the coil on one side in the axial direction, and is capable of accommodating the outer coil end portion of the first coil from one side in the axial direction, and
a second outer notch portion that is provided to overlap an outer coil end portion of the other second coil which is adjacent to the coil on the other side in the axial direction, and is capable of accommodating the outer coil end portion of the second coil from the other side in the axial direction.

4. The coil according to claim 1,
wherein the coil slot portion includes a plurality of layers of planar lamination portions which are laminated in a direction intersecting the axis, and each of which has a thickness in the lamination direction which is less than a skin depth for a frequency of current flowing through the coil slot portion.

5. The coil according to claim 4,
wherein the planar lamination portion extends in the same direction as an extension direction of the coil slot portion.

6. The coil according to claim 1,
wherein the inner notch portion has a depth that is greater than or equal to half a width in the axial direction of a portion of the inner coil end portion, in which the inner notch portion is not formed, and
wherein the outer notch portion has a depth that is greater than or equal to half a width in the axial direction of a portion of the outer coil end portion, in which the outer notch portion is not formed.

7. The coil according to claim 1, further comprising:
a wire rod in which a plurality of magnetic materials independent of each other are superimposed on each other with an insulating material interposed therebetween,
wherein the wire rod is wound multiple times in the peripheral direction around the axis.

8. A coil comprising:
a wire rod in which a plurality of magnetic materials independent of each other are superimposed on each other with an insulating material interposed therebetween,
wherein the wire rod is wound multiple times in a peripheral direction around an axis.

9. An axial-gap type rotating electrical machine comprising:
a stator including a plurality of coils according to claim 1 which overlap each other in an axial direction, and have different phases around an axis;
a casing covering the stator from an outside in a radial direction relative to the axis serving as a center;
a rotor having a permanent magnet, and disposed to face the plurality of coils in the axial direction; and
a rotary shaft supported by the casing, and capable of rotating with the rotor around the axis.

10. The rotating electrical machine according to claim 9,
wherein the casing includes a refrigerant flow path thereinside, through which a refrigerant flows, and
wherein at least part of an outer coil end portion of the stator is disposed in the refrigerant flow path.

11. The rotating electrical machine according to claim 9,
wherein a plurality of stages of the stators and a plurality of stages of the rotors are provided to be spaced apart from each other in the axial direction.

12. The rotating electrical machine according to claim 9,
wherein the stator includes a mold portion supported by the casing, and
wherein the mold portion is made of a composite material.

13. The rotating electrical machine according to claim 12,
wherein the mold portion includes an axial mold portion covering the coils in the axial direction, and
wherein the axial mold portion has a groove accommodating the plurality of coils.

14. The rotating electrical machine according to claim 13,
wherein the axial mold portion includes a peripheral refrigerant flow path through which the refrigerant flows in a peripheral direction around the axis.

15. The rotating electrical machine according to claim 9,
wherein the permanent magnet has a plurality of magnet blocks disposed to line up in the peripheral direction around the axis, and has a ring shape around the axis, and
wherein the rotor includes
a torque transmission portion that is configured to press the permanent magnet to the outside in the radial direction relative to the axis serving as a center, and transmit a rotational torque around the axis, which is applied to the permanent magnet, to the rotary shaft, and
an outer ring portion that is configured to prevent the permanent magnet from being displaced to the outside in the radial direction when a centrifugal force is applied to the permanent magnet.

16. The rotating electrical machine according to claim 15,
wherein the torque transmission portion includes
a key portion that is disposed in the rotary shaft or a keyway formed in an inner ring portion fixed to an outer peripheral surface of the rotary shaft, and is capable of sliding in the radial direction;
a spring portion that is configured to bias the key portion to the outside in the radial direction; and
a surface contact portion that is pressed from an inside in the radial direction by the key portion, and has an outer surface, the entirety of which is in surface contact with an inner peripheral surface of the permanent magnet.

17. The rotating electrical machine according to claim 15,
wherein the torque transmission portion includes
an elastic bending portion having a U-shaped spring portion capable of being compressed and deformed in the radial direction, and
a surface contact portion that is pressed from an inside in the radial direction by the elastic bending portion, and has an outer surface, the entirety of which is in surface contact with an inner peripheral surface of the permanent magnet.

18. A rotating electrical machine comprising:
a stator having a plurality of coils;
a rotor having a permanent magnet, and disposed to face the plurality of coils; and
a rotary shaft capable of rotating with the rotor around an axis,
wherein the permanent magnet has a plurality of magnet blocks disposed to line up in a peripheral direction around the axis, and has a ring shape around the axis, and
wherein the rotor includes
a torque transmission portion that is configured to press the permanent magnet to an outside in a radial direction relative to the axis serving as a center, and transmits a rotational torque around the axis, which is applied to the permanent magnet, to the rotary shaft, and
an outer ring portion that is configured to prevent the permanent magnet from being displaced to the outside in the radial direction when a centrifugal force is applied to the permanent magnet.

19. The rotating electrical machine according to claim 18,
wherein the torque transmission portion includes
a key portion that is disposed in the rotary shaft or a keyway formed in an inner ring portion fixed to an outer peripheral surface of the rotary shaft, and is capable of sliding in the radial direction;
a spring portion that is configured to bias the key portion to the outside in the radial direction; and
a surface contact portion that is pressed from an inside in the radial direction by the key portion, and has an outer surface, the entirety of which is in surface contact with an inner peripheral surface of the permanent magnet.

20. The rotating electrical machine according to claim 18,
wherein the torque transmission portion includes
an elastic bending portion having a U-shaped spring portion capable of being compressed and deformed in the radial direction, and
a surface contact portion that is pressed from an inside in the radial direction by the elastic bending portion, and has an outer surface, the entirety of which is in surface contact with an inner peripheral surface of the permanent magnet.

21. A rotating electrical machine system including the rotating electrical machine according to claim 11, the system comprising:
a power converter converting power generated by the rotating electrical machine,
wherein the power converter includes
a plurality of converters which are each connected to one of a plurality of stators, and are configured to convert AC power of the stators into DC powers, and
a plurality of inverters which are each connected to one of the plurality of converters, and are configured to convert DC power of the converters into AC power,
wherein output terminals of the plurality of inverters outputting the same phase of AC power are connected together in series.

22. The rotating electrical machine system according to claim 21,
wherein one converter is provided for each stage of the stators, and is configured to convert a multiple-phase AC power, which is outputted from each stage of the stators, into a DC power.

23. The rotating electrical machine system according to claim 21,
wherein the converter is provided for each coil of the stator, and is configured to convert single-phase AC power, which is outputted from one coil, into DC power.

24. A rotating electrical machine system comprising:
a generator in which each phase of a coil has a plurality of divided coils, and
a power converter converting a power generated by the generator,
wherein the power converter includes
converters, one of which is connected with each of the divided coils, and is configured to convert AC power of the divided coil into DC power, and
a plurality of inverters which are each connected to one of the plurality of converters, and convert DC power of the converters into AC power,
wherein output terminals of the plurality of inverters outputting the same phase of AC power are connected together in series.

25. A rotating electrical machine system comprising:
a generator provided with a plurality of layers of multiple-phase coils, and
a power converter converting a power generated by the generator,
wherein the power converter includes
converters, one of which is provided for each layer, and is configured to convert a multiple-phase AC power, which is outputted from each layer of the multiple-phase coils, into a DC power, and
a plurality of inverters which are each connected to one of the plurality of converters, and are configured to convert DC power of the converters into AC power,
wherein output terminals of the plurality inverters outputting the same phase of AC power are connected together in series.

26. A method of manufacturing a permanent magnet used in the rotating electrical machine according to claim 9, the method comprising:
setting upper limit values for an eddy current loss and a magnet cost; and
determining the number of divisions of the permanent magnet in a peripheral direction or a radial direction relative to an axis serving as a center within a range where the eddy current loss and the magnet cost do not exceed the upper limit values, according to a relationship between the eddy current loss and the number of divisions of the permanent magnet, and a relationship between the magnet cost and the number of divisions of the permanent magnet.

27. A method of manufacturing a permanent magnet used in the rotating electrical machine according to claim 9, the method comprising:
setting upper limit values for an eddy current loss and a magnet cost; and
determining a magnet aspect ratio of each of a plurality of magnet blocks of the permanent magnet within a range where the eddy current loss and the magnet cost do not exceed the upper limit values, according to a relationship between the eddy current loss and the magnet aspect ratio, and a relationship between the magnet cost and the magnet aspect ratio.

28. A method of manufacturing a permanent magnet used in a rotating electrical machine, the method comprising:
setting upper limit values for an eddy current loss and a magnet cost; and
determining the number of divisions of the permanent magnet in a peripheral direction or a radial direction relative to an axis serving as a center within a range where the eddy current loss and the magnet cost do not exceed the upper limit values, according to a relationship between the eddy current loss and the number of divisions of the permanent magnet, and a relationship between the magnet cost and the number of divisions of the permanent magnet.

29. A method of manufacturing a permanent magnet used in a rotating electrical machine, the method comprising:
setting upper limit values for an eddy current loss and a magnet cost; and
determining a magnet aspect ratio of each of a plurality of magnet blocks of the permanent magnet within a range where the eddy current loss and the magnet cost do not exceed the upper limit values, according to a relationship between the eddy current loss and the magnet aspect ratio, and a relationship between the magnet cost and the magnet aspect ratio.
